(19) United States
(12) Patent Application Publication
(10) Pub. No.: US 2019/0369529 A1
(43) Pub. Date: Dec. 5, 2019

(54) IMAGE FORMING APPARATUS AND IMAGE FORMING METHOD

(71) Applicant: CANON KABUSHIKI KAISHA, Tokyo (JP)

(72) Inventors: Yasutaka Yagi, Mishima-shi (JP); Satoshi Otsuji, Yokohama-shi (JP); Hidekazu Fumita, Gotemba-shi (JP); Masatake Tanaka, Yokohama-shi (JP); Kentaro Yamawaki, Mishima-shi (JP); Atsushi Okuda, Yokohama-shi (JP); Tsutomu Nishida, Mishima-shi (JP)

(21) Appl. No.: 16/423,292

(22) Filed: May 28, 2019

(30) Foreign Application Priority Data
May 31, 2018 (JP) 2018-105575

(51) Int. Cl. G03G 15/16

(52) U.S. Cl. CPC G03G 15/162

(57) ABSTRACT

Provided is an image forming apparatus capable of forming a high quality electrophotographic image. The image forming apparatus includes toner in which an organosilicon polymer is stuck to a toner base at a predetermined sticking ratio, an electrophotographic photoreceptor having a surface layer having a predetermined hardness and a predetermined elastic deformation ratio, and an intermediate transfer body having a surface having a predetermined hardness, and also includes a unit that provides a circumferential velocity difference between the electrophotographic photoreceptor and the intermediate transfer body.

### BACKGROUND

The present disclosure is directed to an image forming apparatus such as a copier, a printer, or a facsimile apparatus using an electrophotographic method or an electrostatic recording method, and an image forming method.

### DESCRIPTION OF THE RELATED ART

In recent years, a long service life and a high speed of an electrophotographic apparatus have been enhanced, and thus improvement of a surface layer of a mounted electrophotographic photoreceptor has been examined in order to improve durability thereof. As an example, Japanese Patent Application Laid-Open No. 2000-66425 discloses a technique for improving wear resistance (mechanical durability) by using a radically polymerizable component on a surface of an electrophotographic photoreceptor. On the other hand, Japanese Patent Application Laid-Open No. 2014-130242 discloses a technique of toner particles each having a surface layer containing an organosilicon polymer as a technique for suppressing deterioration of toner caused by repetitive use due to a long service life of an electrophotographic apparatus.

There is a problem in that a discharge product is attached to a surface of an electrophotographic photoreceptor, and thus image quality is reduced, due to a long service life of an electrophotographic apparatus. Japanese Patent Application Laid-Open No. 2015-87400 discloses a technique of providing a velocity difference (circumferential velocity difference) between a circumferential velocity of an electrophotographic photoreceptor and a circumferential velocity of an intermediate transfer body in order to remove a discharge product attached a surface of the electrophotographic photoreceptor.

### SUMMARY

An aspect of the present invention is directed to providing an image forming apparatus which can form a high quality electrophotographic image.

Another aspect of the present invention is directed to providing an image forming method capable of forming a high quality electrophotographic image.

According to an aspect of the present disclosure, there is provided an image forming apparatus including an electrophotographic photoreceptor; a developing unit that develops toner so as to form a toner image on the electrophotographic photoreceptor; and an intermediate transfer body that conveys a toner image which is primarily transferred from the electrophotographic photoreceptor to be secondarily transferred onto a transfer material. The toner includes a toner particle having a toner base containing a coloring agent and a binder resin, and a surface layer containing an organosilicon polymer, and a sticking ratio of the organosilicon polymer to the toner base is 85.0% or more to 99.0% or less. The electrophotographic photoreceptor has a supporting member, a photosensitive layer, and a surface layer in this order, and a universal hardness value (HU) of the surface layer is 210 or more to 250 or less (N/mm²), and an elastic deformation ratio (We) is 37% or more to 52% or less. A surface of the intermediate transfer body has a universal hardness value (HU) of 50 or more to 100 or less (N/mm²). The image forming apparatus further includes a unit that provides a circumferential velocity difference dVn between a circumferential velocity of the electrophotographic photoreceptor and a circumferential velocity of the intermediate transfer body.

According to another aspect of the present disclosure, there is provided an image forming method including developing toner so as to form a toner image on an electrophotographic photoreceptor; primarily transferring the toner image formed on the electrophotographic photoreceptor onto an intermediate transfer body; and conveying a toner image transferred on the intermediate transfer body to be secondarily transferred onto a transfer material. The toner includes a toner particle having a toner base containing a coloring agent and a binder resin, and a surface layer containing an organosilicon polymer, and a sticking ratio of the organosilicon polymer to the toner base is 85.0% or more to 99.0% or less. The electrophotographic photoreceptor has a supporting member, a photosensitive layer, and a surface layer in this order, and a universal hardness value (HU) of the surface layer is 210 or more to 250 or less (N/mm²), and an elastic deformation ratio (We) is 37% or more to 52% or less. A surface of the intermediate transfer body has a universal hardness value (HU) of 50 or more to 100 or less (N/mm²). In the primarily transferring, a circumferential velocity difference dVn is provided between a circumferential velocity of the electrophotographic photoreceptor and a circumferential velocity of the intermediate transfer body.

Further features of the present invention will become apparent from the following description of exemplary embodiments with reference to the attached drawings.

### BRIEF DESCRIPTION OF THE DRAWINGS

FIG. 1 is a schematic sectional view of an image forming apparatus according to the present disclosure.

FIG. 2 is a schematic sectional view illustrating a layer configuration of an intermediate transfer body.

FIG. 3A is a schematic diagram illustrating a groove shape of a surface of the intermediate transfer body.

FIG. 3B is a schematic diagram illustrating a groove shape of a surface of the intermediate transfer body.

FIG. 4 is a schematic diagram illustrating an image of a section of toner, acquired by using a scanning transmission electron microscope (STEM).

FIG. 5 is a schematic diagram for describing measurement through image analysis of a projection portion containing an organosilicon polymer.

FIG. 6 is a schematic diagram for describing a polishing process for an electrophotographic photoreceptor surface.

### DESCRIPTION OF THE EMBODIMENTS

According to our study, in a case where a circumferential velocity difference is given between an electrophotographic photoreceptor and an intermediate transfer body as disclosed in Japanese Patent Application Laid-Open No. 2015-87400, there is a case where damage occurs on a surface of the electrophotographic photoreceptor, and thus image quality is reduced or it is hard to sufficiently remove a discharge product attached to the surface of the electrophotographic photoreceptor depending on the type of toner, electrophotographic photoreceptor, or intermediate transfer body.

As a result of the examination, we have found an image forming apparatus and an image forming method capable of forming a high quality electrophotographic image by suppressing deterioration in developing property, preventing damage on a surface of an electrophotographic photoreceptor, and suppressing a discharge product from being attached to the surface of the electrophotographic photoreceptor.

<Overall Configuration and Operation of Image Forming Apparatus>

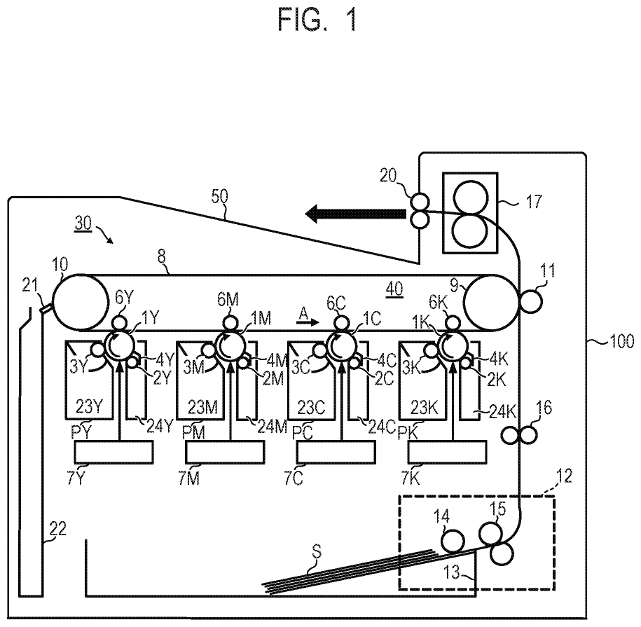

FIG. 1 is a schematic sectional view of an image forming apparatus 100 according to the present aspect. The image forming apparatus 100 is a tandem type (an inline type) laser beam printer which can form a full-color image by using an electrophotographic method and employs an intermediate transfer method.

An image forming section 30 forms a toner image of a plurality of colors, herein, a toner image in which four colors such as yellow (Y), magenta (M), cyan (C), and black (K) overlap each other, on a moving intermediate transfer body 8. Thus, the image forming section 30 is provided with four process cartridges P (PY, PM, PC, and PK) which are attachable to and detachable from a main body of the image forming apparatus 100 as developing units. The image forming section 30 includes an intermediate transfer body unit 40 using the intermediate transfer body 8. The four process cartridges PY, PM, PC, and PK have an identical structure. A difference thereamong is that colors of toner accommodated in the process cartridges P are different from each other, that is, images are formed by using toner having yellow (Y), magenta (M), cyan (C), and black (K).

The process cartridges PY, PM, PC, and PK respectively have toner containers 23Y, 23M, 23C, and 23K. The process cartridges PY, PM, PC, and PK respectively have electrophotographic photoreceptors 1Y, 1M, 1C, and 1K. The process cartridges PY, PM, PC, and PK respectively have charging rollers 2Y, 2M, 2C, and 2K, and developing rollers 3Y, 3M, 3C, and 3K. The process cartridges PY, PM, PC, and PK respectively have drum cleaning blades 4Y, 4M, 4C, and 4K, and waste toner containers 24Y, 24M, 24C, and 24K.

Laser units (exposure devices) 7Y, 7M, 7C, and 7K are disposed under the process cartridges PY, PM, PC, and PK, and performs exposure based on image signals on the electrophotographic photoreceptors 1Y, 1M, 1C, and 1K. Each of the electrophotographic photoreceptors 1Y, 1M, 1C, and 1K is rotationally driven at a predetermined circumferential velocity in a clockwise direction indicated by an arrow. The respective electrophotographic photoreceptors are charged to predetermined negative potentials as a result of a predetermined negative voltage being applied to the charging rollers 2Y, 2M, 2C, and 2K, and then electrostatic latent images are formed thereon through scanning exposure in the laser units 7Y, 7M, 7C, and 7K.

The electrostatic latent images are reversely developed by applying a predetermined negative voltage to the developing rollers 3Y, 3M, 3C, and 3K, and thus color toner images (negative) of Y, M, C, and K are respectively formed on the electrophotographic photoreceptors 1Y, 1M, 1C, and 1K. The above step will be referred to as a developing step.

The intermediate transfer body unit 40 includes the intermediate transfer body 8 which is a flexible endless belt body, and a driving roller 9 and a drive roller 10 around which the intermediate transfer body 8 is hung. Primary transfer rollers (transfer members) 6Y, 6M, 6C, and 6K are disposed to be opposed to the electrophotographic photoreceptors 1Y, 1M, 1C, and 1K inside the intermediate transfer body 8, and are respectively in contact with the corresponding electrophotographic photoreceptors 1 via the intermediate transfer body 8. A contact portion between each electrophotographic photoreceptor 1 and the intermediate transfer body 8 is a primary transfer nip portion. A voltage applying unit (not illustrated) applies a transfer voltage to each primary transfer roller 6.

The intermediate transfer body 8 is rotated (moved) at a predetermined circumferential velocity in a counterclockwise direction as indicated by an arrow A indicating a rotation direction of the intermediate transfer body 8, due to rotational driving of the driving roller 9. The negative toner images respectively formed on the electrophotographic photoreceptors 1Y, 1M, 1C, and 1K are sequentially overlapped with each other to be primarily transferred onto the intermediate transfer body 8 at the primary transfer nip portions in a predetermined manner by applying a positive voltage to the primary transfer rollers 6Y, 6M, 6C, and 6K. In other words, the toner images of four colors such as Y, M, C, and K are formed in an overlapping state in this order on a surface of the intermediate transfer body 8. The above step will be referred to as a primary transfer step.

Subsequently, the intermediate transfer body 8 is rotated (moved), and is conveyed to a secondary transfer nip portion which is a contact portion between the intermediate transfer body 8 and a secondary transfer roller 11.

A feeding/conveying device 12 includes a feeding roller 14 which feeds a transfer material S from the inside of a transfer material cassette 13 in which sheet-like transfer materials S are stacked and stored, and a conveying roller pair 15 which conveys the fed transfer material S. The transfer material S conveyed from the feeding/conveying device 12 is introduced into the secondary transfer nip portion at a predetermined control timing by a resist roller pair 16, and is nipped and conveyed at the secondary transfer nip portion. A positive voltage is applied to the secondary transfer roller 11. Consequently, the overlapped four-color toner images on the intermediate transfer body 8 side are sequentially or collectively secondarily transferred onto the transfer material S nipped and conveyed at the secondary transfer nip portion. The above step will be referred to as a secondary transfer step.

The transfer material S on which the toner images are formed through secondary transfer as mentioned above is introduced into a fixing device 17 as a fixing unit. The transfer material S onto which the toner images are fixed through heating in the fixing device 17 is discharged to a discharge tray 50 by a discharge roller pair 20.

In the respective process cartridges PY, PM, PC, and PK, toner remaining on the surfaces of the electrophotographic photoreceptors after primary transfer of toner images onto the intermediate transfer body 8 from the electrophotographic photoreceptors 1Y, 1M, 1C, and 1K is removed by the drum cleaning blades 4Y, 4M, 4C, and 4K. Toner remaining on the surface of the intermediate transfer body 8 after secondary transfer onto the transfer material S from the intermediate transfer body 8 is removed by a cleaning blade 21 as a cleaning member in counter-contact with the intermediate transfer body 8. The removed toner is recovered in a waste toner recovery container 22.

The image forming apparatus 100 has a unit providing a circumferential velocity difference dVn between a circumferential velocity of the electrophotographic photoreceptor 1 and a circumferential velocity of the intermediate transfer body 8. Each of the electrophotographic photoreceptors 1Y, 1M, 1C, and 1K is rotationally driven by a driving device (not illustrated). The intermediate transfer body 8 is rotated by rotational driving of the driving roller 9. Therefore, a circumferential velocity difference can be provided between a circumferential velocity of the electrophotographic photoreceptor 1 and a circumferential velocity of the intermediate transfer body 8 by using rotational velocities of the driving device and the driving roller 9.

<Effect of Combination of Toner, Electrophotographic Photoreceptor, and Intermediate Transfer Body>

In the present aspect, a combination of toner including a toner particle having a specific surface layer and an electrophotographic photoreceptor having a specific surface layer is used.

The toner according to the present aspect includes a toner particle having a toner base containing a coloring agent and a binder resin, and a surface layer containing an organosilicon polymer, and a sticking ratio of the organosilicon polymer to the toner base is 85.0% or more to 99.0% or less. The sticking ratio is more preferably 90.0% or more to 99.0% or less.

If a sticking ratio is in the above range, since the organosilicon polymer in a surface layer is less peeled or separated, and is not fused to a member in a cartridge, a reduction in development characteristics such as development stripes due to deterioration is suppressed even in repetitive use. In a sticking ratio within the range, in a combination of the toner and the electrophotographic photoreceptor according to the present aspect, separated portions of a minute amount of the organosilicon polymer are attached to a surface layer of the electrophotographic photoreceptor and a surface of the intermediate transfer body. Consequently, a discharge product can be prevented from being attached to a surface of the electrophotographic photoreceptor without damaging the surface of the electrophotographic photoreceptor. A method of measuring a sticking ratio of the surface layer containing the organosilicon polymer to the toner base will be described later. The sticking ratio may be adjusted to the range according to a manufacturing method, a reaction temperature, a reaction time, a reaction solvent, and pH during formation of the organosilicon polymer.

Preferably, the organosilicon polymer contained in the surface layer of the toner particle preferably has a partial structure expressed in the following Formula (B), and the organosilicon polymer is formed in a projection shape in the toner particle surface layer. In this case, a content of the organosilicon polymer in the toner may be 0.5% by mass or more to 5.0% by mass or less, and a projection height of the projection shape is preferably in a range of 40 nm or more to 100 nm or less.

R¹—SiO_{3/2} (B)

R¹ in Formula (B) represents a hydrocarbon group of which the number of carbon atoms is one or more to six or less. A content of the organosilicon polymer is more preferably 1.5% by mass or more to 5.0% by mass or less.

In the organosilicon polymer, among four valences of a Si atom, one is bonded to R¹, and the residual three are bonded to an O atom. The O atom in a state in which both of two valences thereof are bonded to the Si atoms, that is, forms a siloxane bond (Si—O—Si). In other words, the single O atom is shared by the two Si atoms, and thus the O atom per Si atom is ½. In Si atoms and O atoms as the organosilicon polymer, the Si atoms are bonded to three O atoms, and thus a single Si atom has O atoms at ½×3. Thus, —SiO_{3/2} is expressed. The —SiO_{3/2} structure of the organosilicon polymer may have property similar to property of silica (SiO₂) having a plurality of siloxane bonds.

Since a content of the organosilicon polymer is within the range, and the organosilicon polymer has the partial structure expressed by Formula (B), the durability of toner can be improved. A content of the organosilicon polymer can be controlled by using the type and an amount of an organosilicon compound used to form the organosilicon polymer, and a manufacturing method, a reaction temperature, a reaction time, a reaction solvent, and pH during formation of the organosilicon polymer. A method of measuring a content of the organosilicon polymer will be described later.

Since a content of the organosilicon polymer and a projection height of the projection shape have values in the ranges, separated portions of a minute amount of the organosilicon polymer are attached to a surface layer of the electrophotographic photoreceptor and a surface of the intermediate transfer body in projection states. Thus, the surface layer of the electrophotographic photoreceptor and the surface layer of the intermediate transfer body come into contact with each other via projection shapes of toner particles. In the above-described way, even in a case where a circumferential velocity difference is provided between a circumferential velocity of the electrophotographic photoreceptor and a circumferential velocity of the intermediate transfer body, friction between the two can be maintained to be low, and a discharge product can be prevented from being attached to the surface of the electrophotographic photoreceptor without damaging the surface of the electrophotographic photoreceptor.

The Martens hardness measured under a condition of the maximum load of 2.0×10⁻⁴ N is more preferably 200 MPa or more to 1100 MPa or less. If the Martens hardness of toner is within the range, the projection shape of the organosilicon polymer in the toner particle surface layer is more easily maintained, and thus the durability of the toner is improved. Due to the improvement of the durability of the toner, separated portions of a minute amount of the organosilicon polymer are attached to the surface layer of the electrophotographic photoreceptor and the surface of the intermediate transfer body for a long period of time. Thus, even in a case where a circumferential velocity difference is provided between a circumferential velocity of the electrophotographic photoreceptor and a circumferential velocity of the intermediate transfer body, friction between the two can be maintained to be low. As a result, an effect is achieved that a discharge product can be more prevented from being attached to the surface of the electrophotographic photoreceptor without damaging the surface of the electrophotographic photoreceptor.

As a method of measuring the hardness of toner, a weight average particle diameter of toner particles is 3 μm or more to 10 μm or less, and thus a nanoindentation method is preferably used. According to our examination, the Martens hardness representing scratch hardness is appropriate as a definition of hardness. This may be because the Martens hardness can represent strength for toner in a developing machine being rubbed with a hard object such as a metal or an external additive so as to be scratched.

A method of measuring the Martens hardness of toner in the nanoindentation method may be calculated on the basis of an obtained load-displacement curve according to procedures of an indentation test defined in ISO14577 in a commercially available device conforming to ISO14577. In the present disclosure, as a device conforming to the ISO standard, a nanoindentation tester “ENT-1100b” (manufactured by Elionix Corporation) was used. A measurement method is described in the “ENT 1100 operation manual” belonging to the device, but a specific measurement method in the present disclosure is as follows.

Regarding a measurement environment, the inside of a shield case was maintained at 30.0° C. with an attached temperature controller. An atmosphere temperature being maintained to be constant is effective to reduce unevenness of measured data due to thermal expansion or drift. A temperature set in the temperature controller was set to the condition of 30.0° C. supposing a temperature around the developing machine in which toner is rubbed. A standard sample stand attached to the device was used as a sample table, weak air was blown such that toner was scattered after the toner is coated, and the sample stand was set in the device to be held for one or more hours. Thereafter, measurement was performed. The measurement was performed by using, as an indenter, a flat indenter which is attached to the device and of which a front end surface is a flat surface of 20 μm square.

In a case where a sharp indenter is used in an object having a small diameter and a spherical shape, such as toner, an object attached with an external additive, and an object with an uneven surface, measurement accuracy is greatly influenced, and thus a flat indenter is preferably used. The test was performed in a state in which the maximum load in the test was set to 2.0×10⁴ N. The test load is set, and thus the Martens hardness of toner can be measured without destroying a surface layer of a toner particle under the condition corresponding to stress received by a single toner particle in a developing portion. In the present disclosure, friction resistance is important, and thus it is important to measure hardness in a state in which the surface layer is maintained without being destroyed.

Next, a reason why the electrophotographic photoreceptor according to the present aspect contributes to preventing a discharge product from being attached to a surface of the electrophotographic photoreceptor without damaging the surface of the electrophotographic photoreceptor through a combination with the toner even in a case where a circumferential velocity difference is provided between a circumferential velocity of the electrophotographic photoreceptor and a circumferential velocity of the intermediate transfer body, will be described.

The electrophotographic photoreceptor according to the present aspect has a surface layer. The surface layer has a universal hardness value (HU) of 210 or more to 250 or less (N/mm²), and has an elastic deformation ratio (We) of 37% or more to 52% or less. If the universal hardness value (HU) is within the range, in a case where separated portions of a minute amount of the organosilicon polymer are attached to the surface layer of the electrophotographic photoreceptor and the surface of the intermediate transfer body, the surface layer is depressed when a surface of the surface layer comes into contact with and then passes the surface of the intermediate transfer body. Thus, the organosilicon polymers attached to the surface of the surface layer and the surface of the intermediate transfer body may be prevented from being peeled. If the elastic deformation ratio (We) is within the range, the surface of the surface layer to which a separated portion of a minute amount of the organosilicon polymer is attached rapidly removes the depression after coming in contact with and passing the surface of the intermediate transfer body. Therefore, the surface layer of the electrophotographic photoreceptor is prevented from being ground. In the above-described way, since friction between the two can be maintained to be low, a synergy effect that the surface of the electrophotographic photoreceptor is not damaged even in a case where a circumferential velocity difference is provided between a circumferential velocity of the electrophotographic photoreceptor and a circumferential velocity of the intermediate transfer body. If physical property of the surface layer is to be included in the range, this can be achieved by allowing the surface layer to have a partial structure which will be described later and timely optimizing a polymerization condition in manufacturing the surface layer of the electrophotographic photoreceptor.

The surface layer of the electrophotographic photoreceptor according to the present aspect preferably has both of a structure expressed in the following Formula (A-1) and a structure expressed in the following Formula (A-2).

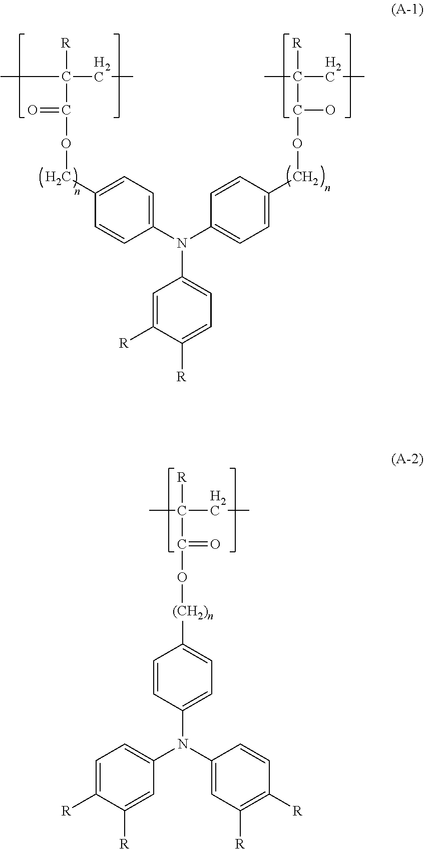

In Formulae (A-1) and (A-2), R represents a hydrogen atom or a methyl group, and n is 2 or 3.

Since the surface layer of the electrophotographic photoreceptor has the structures, and thus an appropriate crosslinking density and disposition of an electron transport structure can be taken, separated portions of a minute amount of the organosilicon polymer may be continuously attached to the surface layer and the surface of the intermediate transfer body. If a total ratio of the structural unit expressed in Formula (A-1) and the structural unit expressed in Formula (A-2) is 60% by mass or more, this is preferable since the effect achieved by the image forming apparatus according to the present aspect can be achieved better. If a ratio of the structural unit expressed in Formula (A-2) to the structural unit expressed in Formula (A-1) is 20% by mass or more to 70% by mass or less, this is more preferable since the surface layer more preferably has an appropriate crosslinking density and disposition of an electron transport structure.

The surface layer of the electrophotographic photoreceptor preferably has a shape in a range of 0.010 μm or more to 0.045 μm or less as Ra, and in a range of 0.005 mm or more to 0.060 mm or less as Sm. Here, Ra indicates an arithmetic average roughness measured through sweeping in a circumferential direction, and Sm indicates an average gap measured through sweeping in the circumferential direction. The surface layer of the electrophotographic photoreceptor preferably has a shape in a range of 0.010 μm or more to 0.030 μm or less as Ra, and in a range of 0.005 mm or more to 0.060 mm or less as Sm. If the surface layer has a roughness in the range, a contact area between the cleaning blade and the surface of the electrophotographic photoreceptor can be reduced while sufficiently ensuring cleaning characteristics. Thus, a separated portion of a minute amount of the organosilicon polymer can be continuously attached, and thus a greater effect can be achieved in terms of achievement of low torque. In a case where the roughness of the surface layer of the electrophotographic photoreceptor satisfies the range, a great effect can be achieved, but the electrophotographic photoreceptor more preferably has a groove shape in the generatrix direction of a circumferential surface of the electrophotographic photoreceptor. As an example, the surface layer may be roughened through polishing using a polishing sheet. The polishing sheet is a sheet-like polishing member formed by providing a layer in which abrasive grains are dispersed in binder resins on a sheet base material. The polishing sheet is sent in a state of being pressed against the surface layer surface, and thus the surface layer can be roughened to have a groove shape. A detailed roughening method will be described later.

In the intermediate transfer body according to the present aspect, the hardness of the surface of the intermediate transfer body is 50 or more to 100 or less (N/mm²) in terms of the universal hardness value (HU). In a combination of the toner and the electrophotographic photoreceptor, an effect of preventing a discharge product from being attached without damaging the electrophotographic photoreceptor surface can be expected. However, more effectively and more preferably, a velocity difference is provided between a circumferential velocity of the electrophotographic photoreceptor and a circumferential velocity of the intermediate transfer body. In the above-described way, a discharge product attached to the electrophotographic photoreceptor can be removed by scraping the discharge product from the intermediate transfer body surface. As described above, a discharge product can be prevented from being attached without damaging the electrophotographic photoreceptor surface through a combination of specific toner and a specific electrophotographic photoreceptor when a circumferential velocity difference is provided.

If the hardness of the surface of the intermediate transfer body is less than 50 (N/mm²) in terms of the universal hardness value (HU), the rigidity is remarkably reduced, and thus the effect of removing a discharge product attached to the electrophotographic photoreceptor surface is reduced. If the hardness is more than 100 (N/mm²), the surface of the intermediate transfer body is too hard with respect to hardness of the electrophotographic photoreceptor surface, there is a high possibility that damage may occur on the electrophotographic photoreceptor surface.

As in the mechanism, the toner particle having the organosilicon polymer in the surface layer thereof, each configuration of the electrophotographic photoreceptor having a specific structure and physical property in the surface layer thereof, and the intermediate transfer body of which the surface hardness has a predetermined range produce effects on each other, and thus the effect of the image forming apparatus according to the present aspect can be achieved in a synergetic manner.

<Description of Electrophotographic Photoreceptor>

The electrophotographic photoreceptor according to the electrophotographic apparatus has a supporting member, and a photosensitive layer and a surface layer on the supporting member.

A method of manufacturing the electrophotographic photoreceptor may include a method of preparing a coating liquid for each layer which will be described later, sequentially applying the coating liquid to a desired layer, and drying the coating liquid. In this case, examples of a method of applying a coating liquid may include dip coating, spray coating, ink jet coating, roll coating, die coating, blade coating, curtain coating, wire bar coating, and ring coating. Above all, the dip coating is preferable in terms of efficiency and productivity.

Hereinafter, each layer will be described.

<Supporting Member>

The supporting member is preferably a conductive supporting member having conductivity. A shape of the supporting member may be a cylindrical member, a belt shape, or a sheet shape. Above all, a cylindrical supporting member is preferably used. An electrochemical process such as anodization, a blast process, or a cutting process may be performed on a surface of the supporting member.

A metal, a resin, or glass is preferably used as a material of the supporting member.

As the metal, aluminum, iron, nickel, copper, gold, stainless steel, or an alloy thereof may be used. Above all, an aluminum supporting member using aluminum is preferably used.

Conductivity may be given to a resin or glass through a process of mixing or coating a conductive material.

<Conductive Layer>

A conductive layer may be provided on the supporting member. The conductive layer is provided, and thus damage or an unevenness of a supporting member surface can be concealed, or reflection of light on the supporting member surface can be controlled.

The conductive layer preferably contains conductive particles and a resin.

Examples of a material of a conductive particle may include a metal oxide, a metal, and carbon black. Examples of the metal oxide may include a zinc oxide, an aluminum oxide, an indium oxide, a silicon oxide, a zirconium oxide, a tin oxide, a titanium oxide, a magnesium oxide, an antimony oxide, and a bismuth oxide. Examples of the metal may include aluminum, nickel, iron, nichorme, copper, zinc, and silver.

Above all, the metal oxide is preferably used as a conductive particle, and, particularly, the titanium oxide, the tin oxide, or the zinc oxide is more preferably used.

In a case where the metal oxide is used as a conductive particle, a surface of the metal oxide may be treated with a silane coupling agent, or the metal oxide may be doped with an element such as phosphor or aluminum, or an oxide thereof.

The conductive particle may have a laminate configuration including a core particle and a coating layer coating the particle. Examples of the core particle may include titanium oxide, barium sulfate, and zinc oxide. The coating layer may be a metal oxide such as tin oxide.

In a case where the metal oxide is used as the conductive particle, a volume advice particle diameter thereof is preferably 1 nm or more to 500 nm or less, and is more preferably 3 nm or more to 400 nm or less.

Examples of the resin may include polyester resin, polycarbonate resin, polyvinyl acetal resin, an acrylic resin, silicone resin, an epoxy resin, melamine resin, polyurethane resin, phenol resin, and alkyd resin.

The conductive layer may further contain a concealing agent such as a silicone oil, a resin particle, or a titanium oxide.

An average film thickness of the conductive layer is preferably 1 μm or more to 50 μm or less, and is particularly preferably 3 μm or more to 40 μm or less.

The conductive layer may be formed by preparing a coating liquid for conductive layer, containing each of the materials and a solvent, forming a coating film, and drying the coating film. Examples of the solvent used for a coating liquid may include alcohol solvents, sulfoxide solvents, ketone solvents, ether solvents, ester solvents, and aromatic hydrocarbon solvents. Examples of a method of dispersing conductive particles in a coating liquid for conductive layer may include methods using a paint shaker, a sand mill, a ball mill, and a wet collision type high-speed dispersing machine.

<Under Coating Layer>

An under coating layer may be provided on the supporting member or the conductive layer. The under coating layer is provided, and thus an adhesiveness function between layers is increased such that a charge injection preventing function can be given.

The under coating layer preferably contains a resin. A cured film may be formed as the under coating layer by polymerizing a composition containing a monomer having a polymerizable functional group.

Examples of the resin may include polyester resin, polycarbonate resin, polyvinyl acetal resin, an acrylic resin, epoxy resin, melamine resin, polyurethane resin, polyurethane resin, phenol resin, polyvinyl phenol resin, an alkyd resin, polyvinyl alcohol resin, polyethylene oxide resin, polypropylene oxide resin, polyamide resin, polyamide acid resin, polyimide resin, polyamide imide resin, and cellulose resin.

Examples of a polymerizable functional group of a monomer may include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

The under coating layer may further contain an electron transport material, a metal oxide, a metal, or a conductive polymer in order to increase electrical characteristics. Above all, the electron transport material or the metal oxide is preferably used.

Examples of the electron transport material may include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron compound. An electron transport material having a polymerizable functional group may be used as an electron transport material, and may be copolymerized with the monomer having the polymerizable functional group such that a cured film is formed as the under coating layer.

Examples of the metal oxide may include an indium tin oxide, a tin oxide, an indium oxide, a titanium oxide, a zinc oxide, an aluminum oxide, and a silicon dioxide. Examples of the metal may include gold, silver, and aluminum.

The under coating layer may further contain an additive.

An average film thickness of the under coating layer is preferably 0.1 μm or more to 50 μm or less, more preferably 0.2 μm or more to 40 μm or less, and most preferably 0.3 μm or more to 30 μm or less.

The under coating layer may be formed by preparing a coating liquid for the under coating layer, containing each of the materials and a solvent, forming a coating film, and drying and/or curing the coating film. Examples of the solvent used for a coating liquid may include alcohol solvents, ketone solvents, ether solvents, ester solvents, and aromatic hydrocarbon solvents.

<Photosensitive Layer>

A photosensitive layer of the electrophotographic photoreceptor is roughly classified into (1) a laminate type photosensitive layer and (2) a single-layer type photosensitive layer. (1) The laminate type photosensitive layer includes a charge generating layer containing a charge generating material and a charge transport layer containing a charge transport material. (2) The single-layer type photosensitive layer includes a photosensitive layer containing both of a charge generating material and a charge transport material.

(1) Laminate Type Photosensitive Layer

The laminate type photosensitive layer includes the charge generating layer and the charge transport layer.

(1-1) Charge Generating Layer

The charge generating layer preferably contains a charge generating material and a resin.

Examples of the charge generating material may include azo pigments, perylene pigments, polycyclic quinone pigments, indigo pigments, and phthalocyanine pigments. Above all, the azo pigments and the phthalocyanine pigments are preferably used. Among the phthalocyanine pigments, an oxytitanium phthalocyanine pigment, a chlorogallium phthalocyanine pigment, and a hydroxygallium phthalocyanine pigment are preferably used.

A content of the charge generating material in the charge generating layer is preferably 40% by mass or more to 85% by mass or less, and is more preferably 60% by mass or more to 80% by mass or less, with respect to the total mass of the charge generating layer.

Examples of the resin may include polyester resin, polycarbonate resin, polyvinyl acetal resin, polyvinyl butyral resin, an acrylic resin, silicone resin, epoxy resin, melamine resin, polyurethane resin, phenol resin, polyvinyl alcohol resin, cellulose resin, polystyrene resin, polyvinyl acetate resin, and polyvinyl chloride resin. Above all, the polyvinyl butyral resin is more preferably used.

The charge generating layer may further contain an additive such as an antioxidant or an ultraviolet absorber. Specific examples of the additive may include hindered phenolic compounds, hindered amine compounds, sulfur compounds, phosphorus compounds, and benzophenone compounds.

An average film thickness of the charge generating layer is preferably 0.1 μm or more to 1 μm or less, and is more preferably 0.15 μm or more to 0.4 μm or less.

The charge generating layer may be formed by preparing a coating liquid for the charge generating layer, containing each of the materials and a solvent, forming a coating film, and drying the coating film. Examples of the solvent used for a coating liquid may include alcohol solvents, sulfoxide solvents, ketone solvents, ether solvents, ester solvents, and aromatic hydrocarbon solvents.

(1-2) Charge Transport Layer

In a case where the electrophotographic photoreceptor according to the present aspect does not have a protective layer, the charge transport layer serves as a surface layer of the electrophotographic photoreceptor. In other words, the charge transport layer has the universal hardness value (HU) of 210 or more to 250 or less (N/mm²), and has the elastic deformation ratio (We) of 37% or more to 52% or less.

The charge transport layer preferably contains a charge transport material and a resin.

Examples of the charge transport material may include polycyclic aromatic compounds, heterocyclic compounds, hydrazone compounds, styryl compounds, enamine compounds, benzidine compounds, triarylamine compounds, and resins having a group derived from these materials. Above all, triarylamine compounds and benzidine compounds are preferably used.

In a case where the charge transport layer is a surface layer, the charge transport layer preferably has both of the structure expressed in Formula (A-1) and the structure expressed in Formula (A-2).

Examples of the resin may include polyester resin, polycarbonate resin, acrylic resin, and polystyrene resin. Above all, the polycarbonate resin and the polyester resin are preferably used. As the polyester resin, particularly, a polyarylate resin is preferably used.

In a case where the charge transport layer is a surface layer, a total ratio of the structural units expressed in Formula (A-1) and in Formula (A-2) in the charge transport layer is preferably 60% by mass or more.

In a case where the electrophotographic photoreceptor according to the present aspect has a protective layer, that is, the charge generating layer is not a surface layer, a content of the charge transport material in the charge transport layer is preferably 25% by mass or more to 70% by mass or less, and is more preferably 30% by mass or more to 55% by mass or less, with respect to the total mass of the charge generating layer. A content ratio (mass ratio) between the charge transport material and the resin is preferably 4:10 to 20:10, and is more preferably 5:10 to 12:10.

The charge transport layer may contain an additive such as an antioxidant, an ultraviolet absorber, a plasticizer, a leveling agent, a slipperiness imparter, or a wear resistance improver. Specific examples of the additive may include hindered phenol compounds, hindered amine compounds, sulfur compounds, phosphorus compounds, benzophenone compounds, siloxane modified resins, silicone oils, fluorine resin particles, polystyrene resin particles, polyethylene resin particles, silica particles, alumina particles, and boron nitride particles.

An average film thickness of the charge transport layer is preferably 5 μm or more to 50 μm or less, more preferably 8 μm or more to 40 μm or less, and most preferably 10 μm or more to 30 μm or less.

The charge transport layer may be formed by preparing a coating liquid for the charge transport layer, containing each of the materials and a solvent, forming a coating film, and drying the coating film. Examples of the solvent used for a coating liquid may include alcohol solvents, ketone solvents, ether solvents, ester solvents, and aromatic hydrocarbon solvents. Among the solvents, the ether solvents or the aromatic hydrocarbon solvents are preferably used.

(2) Single-Layer Type Photosensitive Layer

The single-layer type photosensitive layer may be formed by preparing a coating liquid for the photosensitive layer, containing a charge generating material, a charge transport material, a resin, and a solvent, forming a coating film, and drying the coating film. The charge generating material, the charge transport material, and the resin are the same as the materials exemplified in “(1) the laminate type photosensitive layer.”

In a case where the electrophotographic photoreceptor does not have a protective layer, the photosensitive layer serves as a surface layer. In other words, the photosensitive layer has the universal hardness value (HU) of 210 or more to 250 or less (N/mm²), and has the elastic deformation ratio (We) of 37% or more to 52% or less.

<Protective Layer>

The electrophotographic photoreceptor according to the present aspect may have a surface layer serving as a protective layer on the photosensitive layer. In a case where the electrophotographic photoreceptor has a protective layer, the protective layer serves as a surface layer.

As described above, the protective layer as a surface layer has the universal hardness value (HU) of 210 or more to 250 or less (N/mm²), and has the elastic deformation ratio (We) of 37% or more to 52% or less.

A cured film may be formed as the protective layer by polymerizing a composition containing a monomer having a polymerizable functional group. A reaction at that time may be a thermal polymerization reaction, a photopolymerization reaction, a radiation polymerization reaction. Examples of a polymerizable functional group of a monomer may include an acrylic group and a methacrylic group. As the monomer having a polymerizable functional group, a material having a charge transport function may be used.

Examples of the monomer having a polymerizable functional group having a charge transport function may include the following compounds. Above all, in a case where the protocol is formed by using a combination of Formulae (A-11) to (A-16), Formula (A-21), Formula (A-22), and Formulae (A-25) to (A-30), this is particularly preferable from the viewpoint of effectively achieving the effect of the present invention.

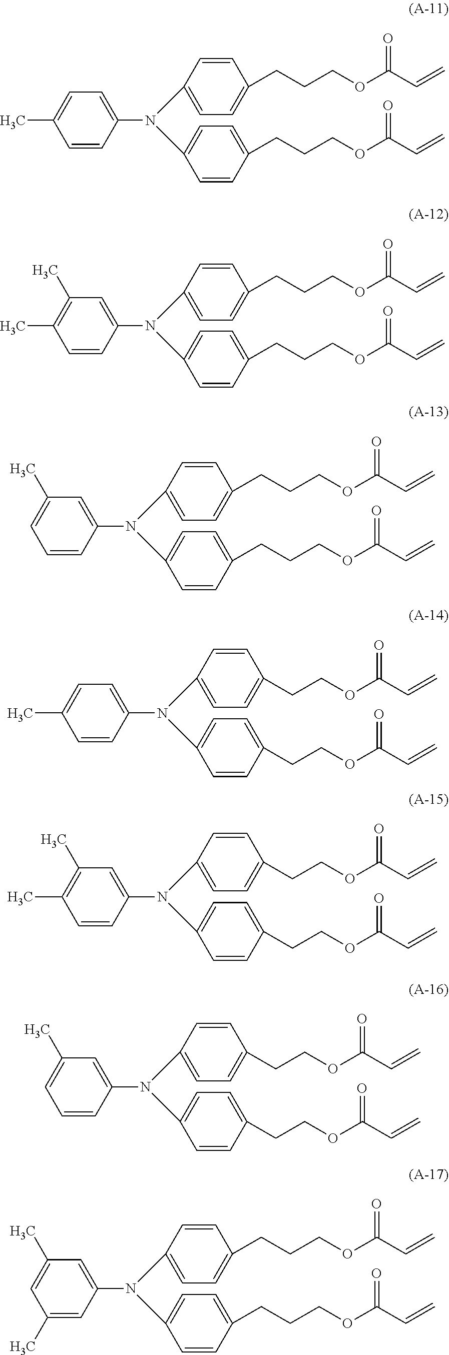

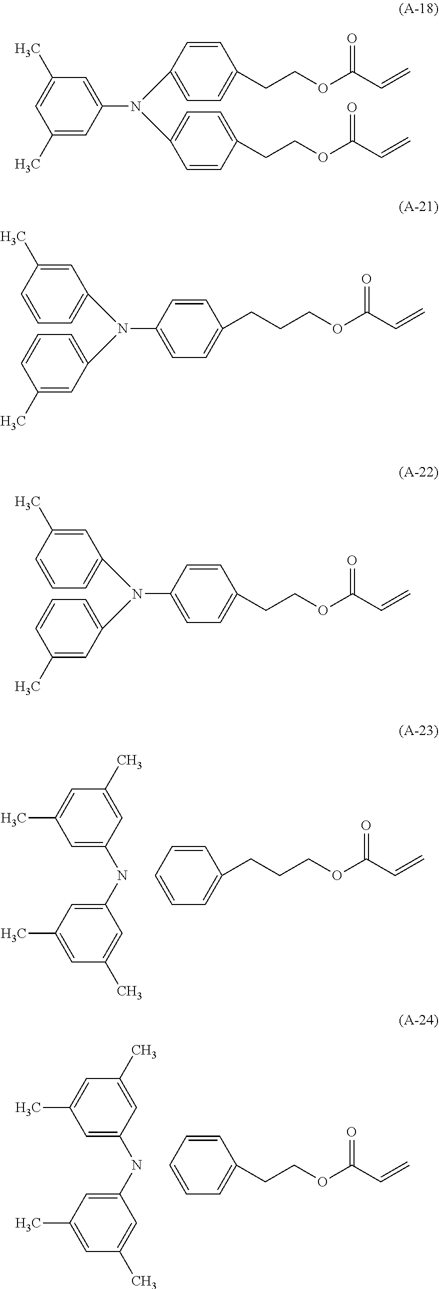

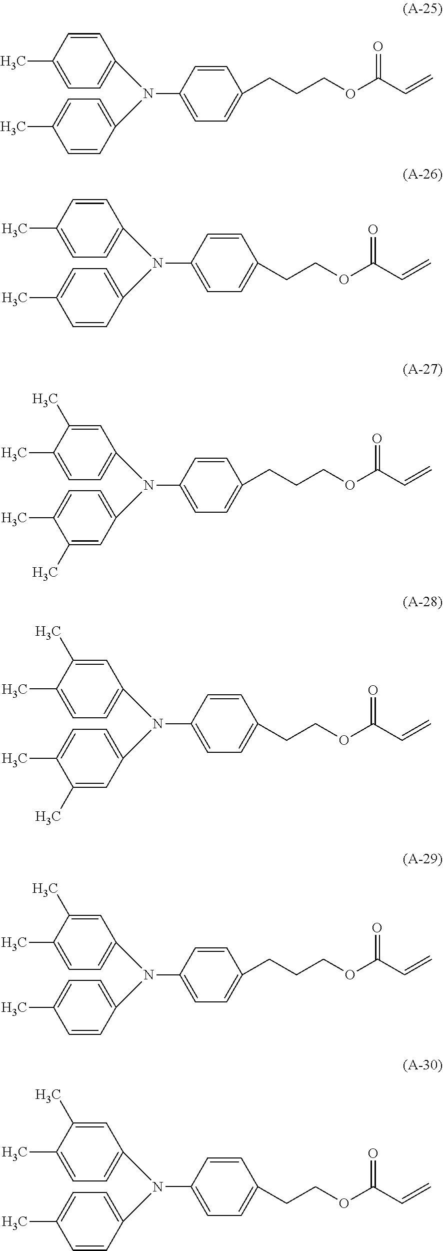

The protective layer may contain an additive such as an antioxidant, an ultraviolet absorber, a plasticizer, a leveling agent, a slipperiness imparter, or a wear resistance improver. Specific examples of the additive may include hindered phenol compounds, hindered amine compounds, sulfur compounds, phosphorus compounds, benzophenone compounds, siloxane modified resins, silicone oils, fluorine resin particles, polystyrene resin particles, polyethylene resin particles, silica particles, alumina particles, and boron nitride particles.

The protective layer may contain conductive particles and/or a charge transport material, and a resin.

Examples of the conductive particles may include particles of a metal oxide such as a titanium oxide, a zinc oxide, a tin oxide, and an indium oxide.

Examples of the charge transport material may include polycyclic aromatic compounds, heterocyclic compounds, hydrazone compounds, styryl compounds, enamine compounds, benzidine compounds, triarylamine compounds, and resins having a group derived from these materials. Above all, triarylamine compounds and benzidine compounds are preferably used.

Examples of the resin may include a polyester resin, an acrylic resin, a phenoxy resin, a polycarbonate resin, a polystyrene resin, a phenol resin, a melamine resin, and an epoxy resin. Above all, the polycarbonate resin, the polyester resin, and the acrylic resin are preferably used.

An average film thickness of the protective layer is preferably 0.5 μm or more to 10 μm or less, and is more preferably 1 μm or more to 7 μm or less.

The protective layer may be formed by preparing a coating liquid for the protective layer, containing each of the materials and a solvent, forming a coating film, and drying and/or curing the coating film. Examples of the solvent used for a coating liquid may include alcohol solvents, ketone solvents, ether solvents, sulfoxide solvents, ester solvents, and aromatic hydrocarbon solvents.

<Description of Toner>

<Surface Layer>

The toner according to the present aspect contains toner particles, and each toner particle has a surface layer. The surface layer is a layer which coats a toner base and is present on a surface of the toner particle. The surface layer according to the present aspect is considerably hard compared with a surface layer of a toner particle of the related art, and thus a portion in which the surface layer is not formed on a part of a surface of the toner base is preferably provided. However, a proportion of the number of division axes in which a thickness of the surface layer is 2.5 nm or less is preferably 20.0% or less. This condition indicates that at least 80.0% of the surface layer of the toner particle is a surface layer having a thickness of 2.5 nm or more. In other words, if this condition is satisfied, the surface layer sufficiently coats the surface of the toner base. More preferably, the proportion is 10.0% or less. A proportion of the number of division axes in which a thickness of the surface layer of the toner particle is 2.5 nm or less may be measured through section observation using a transmission electron microscope (TEM).

The surface layer of the toner particle of the toner according to the present aspect contains an organosilicon polymer, and a sticking ratio of the organosilicon polymer to the toner base is 85.0% or more to 99.0% or less. The organosilicon polymer preferably has the partial structure expressed in Formula (B). In X-ray photoelectron spectroscopic analysis (ESCA) for the surface of the toner particle, in a case where a sum of a carbon atom concentration dC, an oxygen atom concentration dO, and a silicon atom concentration dSi is 100.0 atomic %, the silicon atom concentration dSi is preferably 2.5 atomic % or more to 28.6 atomic % or less.

R¹—SiO_{3/2} (B)

R¹ in Formula (B) represents a hydrocarbon group of which the number of carbon atoms is one or more to six or less.

In the organosilicon polymer, with respect to four valences of a Si atom, one is bonded to R¹, and the residual three are bonded to an O atom. The O atom in a state in which both of two valences thereof are bonded to the Si atoms, that is, forms a siloxane bond (Si—O—Si). In other words, the single O atom is shared by the two Si atoms, and thus the O atom per Si atom is ½. In Si atoms and O atoms as the organosilicon polymer, the Si atoms are bonded to three O atoms, and thus a single Si atom has O atoms at ½×3. Thus, —SiO_{3/2} is expressed. The —SiO_{3/2} structure of the organosilicon polymer may have property similar to property of silica (SiO₂) having a plurality of siloxane bonds. Therefore, the structure may be closer to an inorganic substance than a toner particle of which a surface layer is formed by using an organic resin of the related art, and may thus increase the Martens hardness.

The ESCA is to analyze an atom concentration in a surface layer which is present at a thickness of several nm in a direction from a surface of a toner particle to the center (a midpoint of a major axis) of the toner particle. In a case where the silicon atom concentration dSi in the surface layer of the toner particle is 2.5 atomic % or more, the surface free energy of the surface layer can be reduced such that fluidity improves, and thus member contamination or the occurrence of fogging can be prevented. On the other hand, the silicon atom concentration dSi is preferably 28.6 atomic % or less from the viewpoint of chargeability. If the silicon atom concentration dSi is 28.6 atomic % or less, a charge increase can be suppressed.

The silicon atom concentration in the surface layer in the toner particle can be controlled by using the type of organosilicon compound used to form the organosilicon polymer and an amount thereof. The silicon atom concentration may also be controlled by using a structure of IV in Formula (B), a method of manufacturing a toner particle, a reaction temperature, a reaction time, a reaction solvent, and pH during formation of the organosilicon polymer.

The toner has 20% or more as a proportion of the peak area attributed to the structure in Formula (B) to the total peak area of the organosilicon polymer in a chart obtained through measurement of the ²⁹Si-NMR of tetrahydrofuran (THF) insolubles of the toner particles. Although a detailed measurement method will be described later, this approximates that a partial structure represented by R¹—SiO_{3/2} is present at 20% or more in the organosilicon polymer contained in the toner particle. As described above, the partial structure of —SiO_{3/2} indicates that three of the four valences of the Si atom are bonded to an oxygen atom, and the oxygen atom is bonded to another Si atom. If one of the oxygen atom is replaced with a silanol group, a partial structure of the organosilicon polymer is expressed by R¹—SiO_{2/2}—OH. If two oxygen atoms are replaced with silanol groups, a partial structure thereof is expressed by R¹—SiO_{1/2}—(OH)₂. When these structures are compared with each other, more oxygen atoms forming a crosslinking structure with Si atoms comes close to a silica structure expressed by SiO₂. Thus, as the number of —SiOz_{3/2} skeletons is increased, the surface free energy of the toner particle surface can be reduced, and thus there is an effect that environmental stability and member contamination resistance are excellent. On the other hand, as the number of —SiO_{3/2} skeletons is reduced, the number of silanol groups which are strongly negatively charged is increased, and thus a charge increase cannot be prevented. Therefore, a partial structure represented by R¹—SiO_{3/2} is required to be present at 20% or more. From the viewpoint of charging and durability, the partial structure is preferably preset at 100% or less, and is more preferably present at 40% or more to 80% or less.

Due to the durability of the partial structure, and the hydrophobicity and the chargeability of R¹ in Formula (B), bleeding of a resin having a low molecular weight (Mw of 1000 or less) and a resin having low Tg (40° C. or lower) which are present further toward the inside than the surface layer and easily bleed, and a releasing agent depending on cases can be suppressed.

A proportion of the peak area of the partial structure may be controlled by using the type and an amount of an organosilicon compound used to form the organosilicon polymer, and a reaction temperature, a reaction time, a reaction solvent, and pH in hydrolysis, addition polymerization, and condensation polymerization during formation of the organosilicon polymer.

In the partial structure represented by Formula (B), R¹ is preferably a hydrocarbon group of which the number of carbon atoms is one or more to six or less. In a case where the hydrophobicity of R¹ increases, the chargeability tends to greatly vary in various environments. In a case where R¹ is an aliphatic hydrocarbon group or a phenyl group of which the number of carbon atoms is one or more to five or less, this is preferable since the toner is excellent in environmental stability.

In a case where R¹ is an aliphatic hydrocarbon group or a phenyl group of which the number of carbon atoms is one or more to three or less, this is more preferable since the chargeability and the fogging prevention are further improved. In a case where the chargeability is favorable, transfer property of toner is improved, and thus less toner remains on a surface of an electrophotographic photoreceptor or an intermediate transfer body. Therefore, an electrophotographic photoreceptor, a charging member, and a transfer member are suppressed from being contaminated.

Examples of the aliphatic hydrocarbon group or a phenyl group of which the number of carbon atoms is one or more to three or less may include a methyl group, an ethyl group, a propyl group, and a vinyl group. Particularly preferably, R¹ is a methyl group from the viewpoint of environmental stability and storage stability of toner.

A representative manufacturing example of the organosilicon polymer may include a method called a sol-gel method. The sol-gel method is a method in which a liquid raw material used as a starting raw material is subjected to hydrolysis and condensation polymerization, and is gelled through a sol state, and is used as a method of combining glass, ceramics, an organic-inorganic hybrid material, and a nanocomposite with each other. In a case of using the manufacturing method, functional materials having various shapes, such as a surface layer, a fiber, a bulk body, and a particulate can be manufactured from a liquid phase at a low temperature.

The organosilicon polymer present in the surface layer of the toner particle is preferably generated, for example, through hydrolysis and condensation polymerization of a silicon compound typified by alkoxysilane.

The surface layer containing the organosilicon polymer is provided in the toner particle, and thus it is possible to obtain toner of which environmental stability is improved, perform deterioration hardly occurs in the long-term use, and storage stability is excellent.

In the sol-gel method, a material is formed by starting from a liquid and gelling the material, and thus various fine structures and shapes can be made. Particularly, in a case where a toner particle is manufactured in an aqueous medium, the hydrophilicity of a hydrophilic group such as a silanol group of an organosilicon compound facilitates deposition on a surface of the toner particle. The fine structures and shapes may be adjusted according to a reaction temperature, a reaction time, a reaction solvent, pH, or the type and an amount of an organic metal compound.

The organosilicon polymer is preferably obtained through condensation polymerization of an organosilicon compound represented by the following Formula (Z).

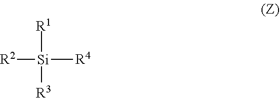

In Formula (Z), R¹ represents a hydrocarbon group of which the number of carbon atoms is one or more to six or less, and R², R³, and R⁴ each independently represent a halogen atom, a hydroxyl group, an acetoxy group, or an alkoxy group.

It is possible to obtain a toner particle of which the hydrophobicity can be improved due to the hydrocarbon group of R¹, and environmental stability is excellent. As the hydrocarbon group, not only an aliphatic hydrocarbon group but also an aryl group which is an aromatic hydrocarbon group, for example, a phenyl group may be used. In a case where the hydrophobicity of R¹ is great, the chargeability tends to greatly vary in various environments, and R¹ is more preferably an aliphatic hydrocarbon group of which the number of carbon atoms is one or more to three or less from the viewpoint of environmental stability.

R², R³, and R⁴ each independently represent a halogen atom, a hydroxyl group, an acetoxy group, or an alkoxy group (hereinafter, also referred to as a reactive group). Such a reactive group forms a crosslinking structure through hydrolysis, addition polymerization, and condensation polymerization, and thus toner excellent in member contamination resistance and development durability can be obtained. R², R³, and R⁴ are preferably an alkoxy group, and are more preferably a methoxy group or an ethoxy group, from the viewpoint of gentle hydrolysis at the room temperature, and deposition property and coatability on a surface of a toner particle. Hydrolysis, addition polymerization, and condensation polymerization for R², R³, and R⁴ can be controlled by using a reaction temperature, a reaction time, a reaction solvent, and pH.

In order to obtain the organosilicon polymer, one or more organosilicon compounds (hereinafter, also referred to as trifunctional silane) having three reactive groups (R², R³, and R⁴) in a single molecule excluding R¹ in the above Formula (Z) may be combined with each other to be used.

The organosilicon compound represented by the above Formula (Z) may be as follows. Trifunctional methylsilane such as methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxysilane hydroxysilane, methylethoxymethoxyhydroxysilane, or methyl diethoxy hydroxy silane. Trifunctional alkylsilane such as ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, methoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, or hexyltrihydroxysilane. Trifunctional phenylsilane such as phenyltrimethoxysilane, phenyltriethoxysilane, phenyltrichlorosilane, phenyltriacetoxysilane, or phenyltrihydroxysilane.

An organosilicon polymer obtained by using the following organosilicon compounds along with the organosilicon compound represented by Formula (Z) to the extent to which the effect achieved by the image forming apparatus according to the present aspect is not impaired. The organosilicon compound may be an organosilicon compound (tetrafunctional silane) having four reactive groups in a single molecule, an organosilicon compound (biifunctional silane) having two reactive groups in a single molecule, or an organosilicon compound (monofunctional silane) having a single reactive group. Examples thereof may be as follows. Trifunctional vinylsilane such as dimethyldiethoxysilane, tetraethoxysilane, hexamethyldisilazane, 3-aminopropyltrimethoxysilane, 3-aminopropyltriethoxysilane, 3-(2-aminoethyl) aminopropyltrimethoxysilane, 3-(2-amino) ethyl) aminopropyltriethoxysilane, vinyltriisocyanatesilane, vinyltrimethoxysilane, vinyltriethoxysilane, vinyldiethoxymethoxysilane, vinylethoxydimethoxysilane, vinylethoxydihydroxysilane, vinyldimethoxyhydroxysilane, vinylethoxymethoxyhydroxysilane, or vinyldiethoxy hydroxy silane.

A content of the organosilicon polymer in toner is particularly preferably 0.5% by mass or more to 10.5% by mass or less.

In a case where a content of the organosilicon polymer in toner is 0.5% by mass or more, the surface free energy of the surface layer can be further reduced such that fluidity of the toner improves, and thus member contamination or the occurrence of fogging can be prevented. In a case where the content is 10.5% by mass or less, the occurrence of a charge increase can be suppressed. A content of the organosilicon polymer can be controlled by using the type of organosilicon compound used to form the organosilicon polymer and an amount thereof, and a method of manufacturing a toner particle, a reaction temperature, a reaction time, a reaction solvent, and pH during formation of the organosilicon polymer.

The surface layer containing the organosilicon polymer and the toner base are preferably in contact with each other without any gap. Consequently, the occurrence of bleeding of a resin component or a releasing agent contained further toward the inside than the surface layer of the toner particle is suppressed, and thus it is possible to obtain toner excellent in storage stability, environmental stability, and development durability. In addition to the organosilicon polymer, the surface layer may contain a resin such as a styrene-acrylic copolymer resin, a polyester resin, or a urethane resin, or various additives.

<Toner Base>

[Binder Resin]

In the toner according to the present aspect, the toner base of the toner particle contains a binder resin. As the binder resin, a well-known binder resin of the related art may be used without particular limitation. As the binder resin, a vinyl resin or a polyester resin may be preferably used. As the vinyl resin, the polyester resin, and other binder resins, the following resins or polymers may be exemplified. Styrene such as polystyrene or polyvinyl toluene, and monomers of substitution products thereof; styrenic polymers such as styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, Styrene-octyl acrylate copolymer, styrene-dimethylaminoethyl methacrylate copolymer, styrene-methyl methacrylate copolymer, styrene-ethyl methacrylate copolymer, styrene-butyl methacrylate copolymer, styrene-methacrylate acid dimethylaminoethyl copolymer, styrene-vinyl methyl ether copolymer, styrene-vinyl ethyl ether copolymer, styrene-vinyl methyl ketone copolymer, styrene-butadiene copolymer, styrene-isoprene copolymer, styrene-maleic acid copolymer, and styrene-maleic acid ester copolymer; and polymethyl methacrylate, polybutyl methacrylate, polyvinyl acetate, polyethylene, polypropylene, polyvinyl butyral, silicone resin, polyamide resin, epoxy resin, polyacrylic resin, rosin, modified rosin, terpene resin, phenolic resin, aliphatic or alicyclic carbonized carbon Hydrogen resin, and aromatic petroleum resin.

The binder resins may be used alone or in combination.

In the toner according to the present aspect, the binder resin contained in the toner base preferably contains a carboxyl group from the viewpoint of chargeability, and is preferably a resin manufactured by using a polymerizable monomer including the carboxyl group. The binder resin may be, for example, (meth) acrylic acids such as α-ethyl acrylic acid or crotonic acid, and α-alkyl derivative or β-alkyl derivative thereof; unsaturated dicarboxylic acids such as fumaric acid, maleic acid, citraconic acid, and itaconic acid; and unsaturated dicarboxylic acid monoester derivatives such as succinic acid monoacryloyloxyethyl ester, succinic acid monoacryloyloxyethylene ester, phthalic acid monoacryloyloxyethyl ester, and phthalic acid monomethacryloyloxyethyl ester.

As the polyester resin, a resin obtained through condensation polymerization of a carboxylic acid component and an alcohol component which are mentioned below may be used. Examples of the carboxylic acid component may include terephthalic acid, isophthalic acid, phthalic acid, fumaric acid, maleic acid, cyclohexanedicarboxylic acid, and trimellitic acid. Examples of the alcohol component may include bisphenol A, hydrogenated bisphenol, ethylene oxide adduct of bisphenol A, propylene oxide adduct of bisphenol A, glycerin, trimethylolpropane, and pentaerythritol.

The polyester resin may be a polyester resin containing a urea group. As the polyester resin, a carboxyl group at a terminal or the like thereof is not preferably capped.

In the toner according to the present aspect, a resin may have a polymerizable functional group in order to improve a viscosity change of the toner at a high temperature. Examples of the polymerizable functional group may include a vinyl group, an isocyanate group, an epoxy group, an amino group, a carboxyl group, and a hydroxyl group.

[Crosslinking Agent]

In order to control a molecular weight of the binder resin forming the toner base, a crosslinking agent may be added in polymerization of a polymerizable monomer.

Examples of the crosslinking agent may include ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinyl benzene, bis(4-acrylate Roxypolyethoxyphenyl) propane, bis(4-methacryloxypolyethoxyphenyl) propane, and ethylene glycol diacrylate, 1,3-butylene glycol diacrylate, 1,4-butanediol diacrylate, 1,5-pentanediol Diacrylate, 1,6-hexanediol diacrylate, neopentyl glycol diacrylate, diethylene glycol diacrylate, triethylene glycol diacrylate, tetraethylene glycol diacrylate, diacrylate of each polyethylene glycol #200, #400, and #600, dipropylene glycol diacrylate, polypropylene glycol diacrylate, polyester type diacrylate (MANDA manufactured by Nippon Kayaku Co., Ltd.), and a product obtained by replacing acrylate with methacrylate.

An amount of the added crosslinking agent is preferably 0.001% by mass or more to 15.000% by mass or less with respect to the polymerizable monomer.

<Coloring Agent>

In the toner according to the present aspect, a coloring agent is contained in the toner base of the toner particle. As the coloring agent, for example, the following well-known coloring agents may be used without particular limitation.

Examples of a yellow pigment may include a yellow iron oxide, Naples Yellow, Naphthol Yellow S, Hanza Yellow G, Hanza Yellow 10G, Benzidine Yellow G, Benzidine Yellow GR, Quinoline Yellow lake, Permanent Yellow NCG, condensed azo compounds such as Tartrazine lake, isoindolinone compounds, anthraquinone compounds, azo metal complexes, methine compounds, and allylamide compounds. Specific examples may be as follows:

C.I. Pigment Yellow 12, 13, 14, 15, 17, 62, 74, 83, 93, 94, 95, 109, 110, 111, 128, 129, 147, 155, 168, and 180.

Examples of an orange pigment may be as follows:

Permanent Orange GTR, Pyrazolone Orange, Vulcan Orange, Benzidine Orange G, Industlen Brilliant Orange RK, and Industlen Brilliant Orange GK.

Examples of a red pigment may include red ion oxide, Permanent Red 4R, Lisole Red, Ryrazolone Red, Watching Red Calcium Salt, Lake Red C, Laked D, Brilliant Carmine 6B, Brillant Carmine 3B, Eoxin Lake, Rhodamine Lake B, condensed azo compounds such as Alizarin lake, diketo pyrrolopyrrole compounds, anthraquinone, quinacridone compounds, basic dye lake compounds, naphthol compounds, benzimidazolone compounds, thioindigo compounds, and perylene compounds. Specific examples may be as follows:

C.I. Pigment Red 2, 3, 5, 6, 7, 23, 48:2, 48:3, 48:4, 57:1, 81:1, 122, 144, 146, 166, 169, 177, 184, 185, 202, 206, 220, 221, and 254.

Examples of a blue pigment may include copper phthalocyanine compounds such as Alkali Blue lake, Victoria Blue lake, Phthalocyanine Blue, Metal-free Phthalocyanine Blue, Phthalocyanine Blue Partial Chloride, Fast Sky Blue, Indaslen Blue BG and derivatives thereof, anthraquinone compounds, and basic dye lake compounds. Specific examples may be as follows:

C.I. Pigment Blue 1, 7, 15, 15:1, 15:2, 15:3, 15:4, 60, 62, and 66.

Examples of a violet pigment may include Fast Violet B and methyl violet lake.

Example of a green pigment may include Pigment Green B, Malachite Green lake, and Final Yellow Green G. Examples of a white pigment may include zinc flower, titanium oxide, antimony white, and zinc sulfide.

Examples of a black pigment may include carbon black, aniline black, nonmagnetic ferrite, magnetite, and black pigments produced by using the above-described yellow coloring agents, red coloring agents, and blue coloring agents. The coloring agents may be used alone or in combination, and further in a solid solution state.

Depending on a toner manufacturing method, it is necessary to pay attention to polymerization inhibition or releasing of a dispersion medium of a coloring agent. Surface modification may be performed by performing surface treatment on a coloring agent by using a substance not causing polymerization inhibition as necessary. Particularly, a pigment or carbon black frequently causes polymerization inhibition, and thus attention is paid during use thereof.

A content of the coloring agent is preferably 3.0 parts by mass or more to 15.0 parts by mass or less with respect to 100.0 parts by mass of a binder resin or a polymerizable monomer.

<Releasing Agent>

A releasing agent is preferably contained as one of materials forming a toner particle. Examples of the releasing agent which can be used for a toner particle may include paraffin wax, microcrystalline wax, petroleum wax such as petrolactam and derivatives thereof, montan wax and derivatives thereof, hydrocarbon wax and derivatives thereof according to the Fischer Tropsch method, polyethylene, polyolefin wax such as polypropylene and derivatives thereof, carnauba wax, natural wax such as candelilla wax and derivatives thereof, higher aliphatic alcohols, fatty acids such as stearic acid and palmitic acid, or compounds thereof, acid amide waxe, ester wax, ketone, hydrogenated castor oil and derivatives thereof, botanical wax, animal wax, and silicone resin. The derivatives include oxides, block copolymers with vinyl monomers, and graft-modified products. A content of the releasing agent is preferably 5.0 parts by mass or more to 20.0 parts by mass or less with respect to 100.0 parts by mass of a binder resin or a polymerizable monomer.

<Charge Control Agent>

The toner particle may contain a charge control agent. A well-known charge control agent may be used as the charge control agent. Particularly, a charge control agent which is fast in a charging speed, and can stably maintain a constant charging amount is preferably used. In a case where the toner particle is manufactured according to a direct polymerization method, a charge control agent which scarcely causes polymerization inhibition and does not substantially have substances soluble in an aqueous medium is particularly preferably used.

Examples of a charge control agent controlling a toner particle to be negatively charged may be as follows. Monoazo metal compounds as organic metal compounds and chelate compounds, acetylacetone metal compounds, aromatic oxycarboxylic acids, aromatic dicarboxylic acids, and metal compounds based on oxycarboxylic acids and metal compounds of dicarboxylic acids.

Aromatic oxycarboxylic acids, aromatic monocarboxylic acids and polycarboxylic acids and metal salts thereof, anhydrides or esters, and phenol derivatives such as bisphenols are included. Urea derivatives, metal-containing salicylic acid compounds, metal-containing naphthoic acid compounds, boron compounds, quaternary ammonium salts, and calixarenes are also included.

On the other hand, examples of a charge control agent controlling a toner particle to be positively charged may be as follows. Nigrosine-modified products such as nigrosine and fatty acid metal salts; guanidine compounds; imidazole compounds; quaternary ammonium salts such as tributylbenzylammonium-1-hydroxy-4-naphthosulfonate and tetrabutylammonium tetrafluoroborate, onium salts such as phosphonium salts which are analogs thereof, and lake pigments thereof; triphenylmethane dyes and lake pigments thereof (as laking agents, for example, phosphotungstic acid, phosphomolybdic acid, phosphotungstic molybdic acid, tannic acid, lauric acid, gallic acid, and ferricyanide, ferrocyanide); metal salts of higher fatty acids; and resin-based charge control agents.

The charge control agents may be contained alone or in combination of two or more kinds thereof. A content of the charge control agent is preferably 0.01 parts by mass or more to 10.00 parts by mass or less with respect to 100.00 parts by mass of a binder resin.

<External Additive>

A fluidizing agent, a cleaning aid, and the like which are so-called external additives may be added to a toner particle contained in the toner in order to improve fluidity, chargeability, cleaning property, and the like.

Examples of the external additives may include inorganic oxide particulates including silica particulates, alumina particulates, and titanium oxide particulates, inorganic stearic acid compound particulates such as aluminum stearate particulates and zinc stearate particulates, or inorganic titanate compound particulates such as strontium titanate or zinc titanate. The additives may be used alone or in combination of two or more kinds thereof. These inorganic particulates are preferably subjected to gloss processing by using a silane coupling agent, a titanium coupling agent, a higher fatty acid, or a silicone oil, in order to improve heat resistant storage property and environmental stability. A BET specific surface area of the external additive is preferably 10 m²/g or more to 450 m²/g or less.

The BET specific surface area may be obtained according to a BET method (preferably, a BET multipoint adsorption method) by using a low-temperature gas adsorption method based on a dynamic constant-pressure method. For example, the BET specific surface area (m²/g) may be calculated by adsorbing a nitrogen gas onto a sample surface by using a specific surface area measurement device (product name: GEMINI 2375 Ver. 5.0, manufactured by Shimadzu Corporation), and by performing measurement according to the BET multipoint adsorption method.

A total amount of various added external additives is 0.05 parts by mass or more to 5 parts by mass or less with respect to 100 parts by mass of the toner, and is preferably 0.1 parts by mass or more to 3 parts by mass or less. A combination of various external additives may be used.

The toner has a toner particle and a positively charged particle on a surface of the toner particle, and a number average particle diameter thereof is particularly preferably 0.10 μm or more to 1.00 μm or less. In a case where the toner has the positively charged particle, it is clear that transfer efficiency is favorable in the long-term use. A mechanism thereof may be as follows. If the toner has positively charged particles of a number average particle diameter in this range, rolling is possible on a surface of a toner particle, and thus the toner is rubbed between the electrophotographic photoreceptor and the transfer belt to be promoted to be negatively charged. As a result, the transfer efficiency may be favorable since positive charging due to application of a transfer bias is suppressed. The toner is characterized by having a hard surface, and it may be estimated that the transfer efficiency is easily maintained to be high since a positively charged particle is hardly stuck to or buried in a toner surface.

As means for making a positively charged particle present on a toner particle surface, various methods may be used, and, any method may be used, but a method of giving a positively charged particle through external addition is particularly preferably used. If the hardness of the toner is within the range of the present aspect, it has found that positively charged particles can be made present on a toner particle surface uniformly and at a high sticking ratio. A sticking ratio of a positively charged particle to toner is preferably 5% or more to 75% or less. If the sticking ratio is within this range, the transfer efficiency can be maintained to be high by promoting friction charging between the toner particle surface and the positively charged particle. A method of measuring a sticking ratio will be described later. The kind of positively charged particle is preferably hydrotalcite, titanium oxide, and melamine resin. Above all, the hydrotalcite is particularly preferably used.

The toner according to the present aspect particularly preferably has boron nitride on a toner particle surface. It becomes clear that the toner having the boron nitride can suppress the toner from being fused onto a developing member, especially, the developing roller in the long-term use. Thus, even in a supply system, a charging amount of the toner can be maintained in the long-term use. The boron nitride is a material having high heat conductivity. Thus, it is estimated that there is an effect that heat generated due to rubbing with a member during development is easily released, and bleeding of the toner base due to the heat is suppressed.

As means for making the boron nitride present on a toner particle surface, various methods may be used, and, any method may be used, but a method of giving a positively charged particle through external addition is particularly preferably used. If the hardness of the toner is within the range of the present aspect, it has found that boron nitride can be made present on a toner particle surface uniformly and at a high sticking ratio. The boron nitride is a cleavable material. If the hardness of the toner is within the range of the present aspect, it becomes clear that the boron nitride is cleaved due to an external addition operation, and also forms a uniform film on a toner particle surface. A sticking ratio of the boron nitride to toner is preferably 80% or more. If the sticking ratio is within this range, it is possible to more effectively suppress fusion onto the developing roller.

<Developing Agent>

In the toner, a magnetic or non-magnetic single-component developing agent may be used, but a two-component developing agent may be used in combination with a carrier.

As the carrier, for example, metals such as iron, ferrite, and magnetite, and magnetic particles made of well-known materials in the related art, such as alloys of the metals and metals such as aluminum and lead may be used, and, above all, a ferrite particle is preferably used. As the carrier, a coat carrier in which a surface of a magnetic particle is coated with a coating agent such as a resin, or a resin dispersion carrier in which magnetic fine powder is dispersed in a binder resin may be used.

As the carrier, a volume average particle diameter is preferably 15 μm or more to 100 μm or less, and is more preferably 25 μm or more to 80 μm or less.

[Method of Manufacturing Toner Particle]

A toner particle may be manufactured, first, by magnification a core particle of toner by using well-known means for manufacturing the toner particle, and then by forming a surface layer on a surface of the core particle. The well-known means for manufacturing a toner particle may employ a knealing-grinding method or a wet manufacturing method. The wet manufacturing method is preferably used from the viewpoint of uniformation of a particle diameter or shape controllability. Examples of the wet manufacturing method may include a suspension polymerization method, a dissolution suspension method, an emulsion polymerization aggregation method, and an emulsion aggregation method.

Herein, the suspension polymerization method will be described. In the suspension polymerization method, first, a polymerizable monomer composition is prepared by uniformly dissolving or dispersing a polymerizable monomer, a coloring agent, and a salicylic acid resin for synthesizing a binder resin by using a dispersing machine such as a ball mill or an ultrasonic dispersing machine (polymerizable monomer composition preparation step). In this case, a multi-functional monomer, a chain transfer agent, a wax or a charge control agent as a releasing agent, a plasticizer, or the like may be added as appropriate according to the need. As the polymerizable monomer in the suspension polymerization method, the following vinyl-based polymerizable monomers may be preferably exemplified: styrene; styrene derivatives such as α-methylstyrene, β-methylstyrene, o-methylstyrene, m-methylstyrene, p-methylstyrene, 2,4-dimethylstyrene, p-n-butylstyrene, p-tert-butylstyrene, p-n-Hexylstyrene, p-n-octyl, p-n-nonylstyrene, p-n-decylstyrene, p-n-dodecylstyrene, p-methoxystyrene, and p-phenylstyrene; acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyl oxyethyl acrylate; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl ethers such as vinyl acetate, vinyl propionate, vinyl benzoate, vinyl butyrate, vinyl benzoate, and vinyl formate; vinyl ethers such as vinyl methyl ether, vinyl ethyl ether, and vinyl isobutyl ether; and vinyl methyl ketone, vinyl hexyl ketone, and vinyl isopropyl ketone.

Next, the polymerizable monomer composition is put into an aqueous medium which is prepared in advance, and a liquid droplet made of the polymerizable monomer composition is formed to have a desired size of a core particle by using a stirrer or a dispersing machine having high shearing force (granulation step).

The aqueous medium in the granulation step preferably contains a dispersion stabilizer in order to control a particle diameter of a core particle, sharpen a particle size distribution, and suppress unification of core particles. The dispersion stabilizer is generally largely classified into a polymer which makes repellent force exhibited due to steric hindrance, and a hardly water-soluble inorganic compound which achieves dispersion stabilization by using electrostatic repellent force. Particulates of the hardly water-soluble inorganic compound are dissolved by an acid or an alkali, and are thus preferably used since the particulates are dissolved through cleaning with an acid or an alkali so as to be easily removed.

As the dispersion stabilizer of the hardly water-soluble inorganic compound, a dispersion stabilizer including one of magnesium, calcium, barium, zinc, aluminum, and phosphor is preferably used. More preferably, a dispersion stabilizer including one of magnesium, calcium, aluminum, and phosphor is used. Specific examples thereof may be as follows. Magnesium phosphate, tricalcium phosphate, aluminum phosphate, zinc phosphate, magnesium carbonate, calcium carbonate, magnesium carbonate, magnesium hydroxide, calcium hydroxide, aluminum hydroxide, calcium metasilicate, calcium sulfate, barium sulfate, and hydroxyapatide.

Organic compounds, for example, polyvinyl alcohol, gelatin, methyl cellulose, methyl hydroxypropyl cellulose, ethyl cellulose, sodium salt of carboxymethyl cellulose, and starch may be used together for the dispersion stabilizer. These dispersion stabilizers are preferably used in an amount of 0.01 parts by mass or more to 2.00 parts by mass or less with respect to 100 parts by mass of the polymerizable monomer. A surfactant may be used together in an amount of 0.001 parts by mass or more to 0.1 parts by mass or less in order to micronize the dispersion stabilizers. Specifically, commercially available nonionic, anionic, and cationic surfactants may be used. For example, sodium dodecyl sulfate, sodium tetradecyl sulfate, sodium pentadecyl sulfate, sodium octyl sulfate, sodium oleate, sodium laurate, potassium stearate, and calcium oleate are preferably used.

Polymerization is performed at a temperature generally set to 50° C. or more to 90° C. or less after the granulation step or while the granulation step is performed, and thus a core particle dispersion liquid is obtained (polymerization step).

Since a temperature of a treatment liquid has great influence on fixing performance of a core particle, generally, a stirring operation is performed such that a temperature distribution in a vessel is uniform. In a case where a polymerization initiator is added, the stirring operation may be performed at any timing and for any required time. In order to obtain a desired molecular weight distribution, a temperature may be raised in the latter half of a polymerization reaction, and, in order to remove unreacted polymerizable monomers, byproducts, or the like from the system, a part of the aqueous medium may be distilled off through a distillation operation in the latter half of the reaction or after the reaction is finished. The distillation operation may be performed under normal or reduced pressure.

As the polymerization initiator used in the suspension polymerization method, generally, an oil-soluble initiator is used. Examples thereof may be as follows. Azo compounds such as 2,2′-azobisisobutyronitrile, 2,2′-azobis-2,4-dimethyl valeronitrile, 1,1′-azobis (cyclohexane-1-carbonitrile), 2,2′-azobis-4-methoxy-2,4-dimethyl valeronitrile; and peroxide initiators such as acetyl cyclohexyl sulfonyl peroxide, diisopropyl peroxy carbonate, decanonyl peroxide, lauroyl peroxide, stearoyl peroxide, propionyl peroxide, acetyl peroxide, tert-butyl peroxy-2-ethylhexanoate, benzoyl peroxide, tert-Butyl peroxyisobutyrate, cyclohexanone peroxide, methyl ethyl ketone peroxide, dicumyl peroxide, tert-butyl hydroperoxide, di-tert-butyl peroxide, and tert-butyl peroxypivalate, cumene hydroperoxide.

A water-soluble initiator may be used together with the polymerization initiator, and examples thereof may include ammonium persulfate, potassium persulfate, 2,2′-azobis(N,N′-dimethylene isobutyroamidine) hydrochloride, 2,2′-azobis(2-aminodinopropane) hydrochloride, azobis(isobutylamidine) hydrochloride, sodium 2,2′-azobisisobutyronitrile sulfonate, and ferrous sulfate or hydrogen peroxide.

These polymerization initiators may be used alone or in combination, and may also be used by further adding a chain transfer agent, a polymerization inhibitor, and the like thereto in order to control the polymerization degree of the polymerizable monomer.

Regarding a particle diameter of the core particle, a weight average particle diameter is preferably 3.0 μM or more to 10.0 μm or less from the viewpoint of obtaining a high-definition and high-resolution image. A weight average particle diameter of the core particle may be measured according to a pore electric resistance method. The weight average particle diameter may be measured by using, for example, “Coulter counter, Multisizer 3 (manufactured by Beckman Coulter Corporation)”. The core particle dispersion liquid obtained in the above-described way is sent to a filtering step in which the core particle and the aqueous medium are subjected to solid-liquid separation.

The solid-liquid separation for obtaining the core particle from the obtained core particle dispersion liquid may be performed according to a general filtering method, and then further cleaning is preferably performed through cleaning using re-slurry or cleaning water in order to remove a foreign substance which is not removed yet from a core particle surface. After sufficient cleaning is performed, solid-liquid separation is performed again, and thus a cake of core particles is obtained. Thereafter, the cake is dried by well-known drying means, a particle group having predetermined diameters other than a predetermined particle diameter are separated through classification if necessary, and thus core particles are obtained. The particle group having particle diameters other than the predetermined particle diameter may be reused in order to improve a final yield.

Next, a surface layer may be formed on a surface of the core particle manufactured in the above-described way, according to the following method. First, the core particles are dispersed in an aqueous medium, and thus a core particle dispersion liquid is obtained. The core particles in this case are preferably dispersed in a concentration in which a solid content of the core particles is 10% by mass or more to 40% by mass or less with respect to a total amount of the core particle dispersion liquid. A temperature of the core particle dispersion liquid is preferably adjusted to 35° C. or higher. In addition, pH of the core particle dispersion liquid is preferably adjusted to pH at which condensation of an organosilicon compound hardly occurs. Since pH at which condensation of an organosilicon compound hardly occurs differs depending on a compound, pH is preferably set within ±0.5 with respect to pH at which a reaction most hardly occurs.

On the other hand, an organosilicon compound subjected to hydrolysis is preferably used. For example, hydrolysis is performed as a pre-treatment of the organosilicon compound in a separate vessel. Regarding a preparation concentration of the hydrolysis, in a case where an amount of the organosilicon compound is 100 parts by mass, an amount of water from which ion components such as ion-exchanged water and RO water are removed is preferably 40 parts by mass or more to 500 parts by mass or less, and is more preferably 100 parts by mass to 400 parts by mass or less. Regarding conditions for the hydrolysis, preferably, pH is 2 or more to 7 or less, a temperature is 15° C. or more to 80° C. or less, and a time is 30 minutes or more to 600 minutes or less.

The obtained hydrolysis liquid and core particle dispersion liquid are mixed to be adjusted to pH appropriate for condensation, and thus a surface layer can be formed on a core particle surface of the toner while condensing the organosilicon compound. The condensation and formation of the surface layer are preferably performed for 60 minutes or more at 35° C. or higher. A macro structure of the surface can be adjusted by adjusting holding time at 35° C. or higher before adjustment to pH appropriate for condensation, but, if the time is too long, it is hard to obtain toner having a specific Martens hardness, and thus the time is preferably 3 minutes or more to 120 minutes or less.

The surface layer is formed as described above, and thus a balance can be reduced such that a projection shape can be formed in the surface layer. A network structure can be formed between projections, and thus it is easy to obtain toner having the specific Martens hardness.

<Measurement of Content of Organosilicon Polymer in Toner>

Measurement of a content of an organosilicon polymer in toner may be performed by using, for example, a wavelength-dispersion type fluorescent X-ray analysis device “Axios” (manufactured by PANalytical Corporation), and bundled dedicated software “SuperQ ver. 4.0F” (manufactured by PANalytical Corporation) for measurement condition setting and measured data analysis. Hereinafter, a description will be made of a specific measurement method in a case where the device is used.

Rh is used as an anode of an X-ray tube, a measurement atmosphere is vacuum, a measurement diameter (collimator mask diameter) is 27 mm, and a measurement time is 10 seconds. In a case where a light element is measured, detection is performed with a proportional counter (PC), and in a case where a heavy element is measured, detection is performed with a scintillation counter (SC).

As a measurement sample, a pellet which is formed to have a thickness of 2 mm and a diameter of 39 mm, obtained as follows, is used. First, 4 g of toner particles according to the present aspect is placed in a dedicated press aluminum ring and is flattened, and is pressed is used at 20 MPa for 60 seconds by using the tablet forming compressor “BRE-32” (manufactured by Maekawa Testing Machine Co., Ltd.).

Silica (SiO₂) particulates are added to be 0.5 parts by mass to 100 parts by mass of toner particles not containing an organosilicon polymer, and the toner particles and the particulates are sufficiently mixed with each other by using a coffee mill. Similarly, silica particulates are added to be 5.0 parts by mass and 10.0 parts by mass to 100 parts by mass of toner particles not containing an organosilicon polymer, and are mixed with the toner particles, and results thereof are used as calibration curve samples.

A pellet is manufactured as described above by using the tablet forming compressor for each calibration curve sample, and a counting rate (unit: cps) of Si-Kα rays measured at a diffraction angle (20)=109.08° when using pentaerythritol (PET) for a dispersive crystal is measured. In this case, an acceleration voltage and a current value of an X-ray generation device are respectively set to 24 kV and 100 mA. A calibration curve of a linear function is obtained by expressing the obtained X-ray counting rate on a longitudinal axis and expressing an amount of added SiO₂ in each calibration curve sample on a transverse axis.

Next, in the same manner as the calibration curve sample, a counting rate of Si-Kα rays of the pellet formed as a measurement sample is measured. A content of the organosilicon polymer in the toner is obtained on the basis of the calibration curve.

<Method of Calculating Sticking Ratio of Organosilicon Polymer to Toner Base>

160 g of sucrose (manufactured by Kishida Chemical Co., Ltd.) is added to 100 mL of ion-exchanged water, and is dissolved in hot water such that a sucrose concentrate is prepared. 31 g of the sucrose concentrate and 6 mL of Contaminon N (a 10 mass % aqueous solution of a neutral detergent for cleaning precision measuring instruments, having pH 7 and including a nonionic surfactant, a cationic surfactant, and an organic builder) are placed into a tube for centrifugal separation (capacity of 50 mL), and a dispersion liquid is manufactured. 1 g of the toner is added to the dispersion liquid, and thus a lump of the toner is loosened with a spatula or the like.

The tube for centrifugal separation is shaken and washed at 350 strokes per min (spm) for 20 minutes with a shaker.

After shaking, the solution is moved to a swing rotor glass tube (50 mL), and is separated under the conditions of 3500 rpm and 30 minutes in a centrifugal separator (H-9R manufactured by Kokusan Co., Ltd.).

It is visually checked that the toner and the aqueous solution are sufficiently separated from each other, and the toner separated in the uppermost layer is collected with a spatula or the like. An aqueous solution including the collected toner is filtered with a vacuum filter, and is then dried with a drier for an hour or more.

The dried product is crushed with a spatula, and an amount of the organosilicon polymer is determined by using fluorescent X-rays. A sticking ratio (%) of the organosilicon polymer to the toner base is computed on the basis of a content ratio of a measurement target element of the washed toner and the initial toner.

Measurement using fluorescent X-rays for silicon is based on JIS K 0119-1969, and details thereof are as follows.

A wavelength-dispersion type fluorescent X-ray analysis device “Axios” (manufactured by PANalytical Corporation) as a measurement device, and bundled dedicated software “SuperQ ver. 4.0F” (manufactured by PANalytical Corporation) for measurement condition setting and measured data analysis are used.

Rh is used as an anode of an X-ray tube, a measurement atmosphere is vacuum, a measurement diameter (collimator mask diameter) is 10 mm, and a measurement time is 10 seconds. In a case where a light element is measured, detection is performed with a proportional counter (PC), and in a case where a heavy element is measured, detection is performed with a scintillation counter (SC).

As a measurement sample, a pellet which is formed to have a thickness of 2 mm, obtained as follows, is used. That is, about 1 g of the washed toner and the initial toner is placed in the dedicated press aluminum ring with a diameter of 10 mm and is flattened, and is pressed at 20 MPa for 60 seconds by using the tablet forming compressor “BRE-32” (manufactured by Maekawa Testing Machine Co., Ltd.).

Measurement is performed under the conditions, elements are identified on the basis of obtained peak positions of X-rays, and concentrations thereof are calculated on the basis of a counting rate (unit: cps) which is the number of X-ray photons per unit time.

As a quantitative determination method of the organosilicon polymer in the toner, silica (SiO₂) particulates are added to be 0.5 parts by mass to 100 parts by mass of toner particles not containing an organosilicon polymer, and the toner particles and the particulates are sufficiently mixed with each other by using a coffee mill. Similarly, silica particulates are mixed to be 2.0 parts by mass and 5.0 parts by mass with the toner, and results thereof are used as calibration curve samples. As described in <Measurement of content of organosilicon polymer in toner>, a pellet of the calibration curve sample is manufactured by using the tablet forming compressor for each calibration curve sample, and a counting rate (unit: cps) of Si-Kα rays measured at a diffraction angle (20)=109.08° when using PET for a dispersive crystal is measured. In this case, an acceleration voltage and a current value of an X-ray generation device are respectively set to 24 kV and 100 mA. A calibration curve of a linear function is obtained by expressing the obtained X-ray counting rate on a longitudinal axis and expressing an amount of added SiO₂ in each calibration curve sample on a transverse axis.

Next, similarly, the analysis target toner is generated as a pellet by using the tablet forming compressor, and a counting rate of Si-Kα rays of the pellet is measured. A content of the organosilicon polymer in the toner is obtained on the basis of the calibration curve. A ratio of an element content of the washed toner to an element content of the initial toner calculated according to the method is obtained, and is used as a sticking ratio (%) of the organosilicon polymer to the toner base.

<Method of Checking Structure Represented by Formula (B)>

Among the structures represented by Formula (B), a structure such as a hydrocarbon group bonded to a Si atom may be checked by using ¹³C-NMR (solid).

Detailed structures of Formula (B) may be checked by using ¹³C-NMR (solid) and ²⁹Si-NMR (solid).

A device which has been used, measurement conditions, and a sample preparation method will be described below.

“Measurement Conditions for ¹³C-NMR (Solid)”

Device: JNM-ECX500II manufactured by JEOL RESONANCE

Sample tube: 3.2 mmϕ

Sample: 150 mg of tetrahydrofuran-insoluble component of toner particles for NMR measurement

Measurement temperature: room temperature

Plus mode: CP/MAS

Measurement nuclear frequency: 123.25 MHz (13C)

Reference substance: adamantane (external standard: 29.5 ppm)

Sample rotation speed: 20 kHz

Contact time: 2 ms

Delay time: 2 s

Number of integrations: 1024

In the method, a hydrocarbon group expressed by R¹ in Formula (B) can be checked on the basis of the presence or absence of signals caused by a methyl group (Si—CH3), an ethyl group (Si—C2H5), a propyl group (Si—C3H7), a butyl group (Si—C4H9), a pentyl group (Si—C5H11), a hexyl group (Si—C6H13), a phenyl group (Si—C6H5), and the like bonded to the Si atom.

In a case where a partial structure expressed in the above Formula (1) is required to be checked in more detail, the partial structure may be identified on the basis of a measurement result using ¹H-NMR along with a measurement result using ¹³C-NMR.

<Measurement of Projection Height of Organosilicon Polymer in Toner Particle>

A projection height of the organosilicon polymer in the toner particle may be measured by manufacturing a section of the toner, acquiring an image of the obtained section of the toner by using a scanning transmission electron microscope (STEM), and performing image analysis on the obtained image.

Hereinafter, a description will be made of procedures of manufacturing a section of the toner.

The toner is sprayed in a single layer on a cover glass (Matsunami Glass Ind., Ltd., corner cover glass; square No. 1), and an Os film (5 nm) and a naphthalene film (20 nm) are applied as a protective film by using an osmium plasma coater (Filgen, Inc., OPC80T). Next, a tube (01.5 mm×13 mm×3 mm) made of PTFE is filled with a photocurable resin “D800” (JEOL Ltd.), and the cover glass is placed on the tube in a direction in which the toner seems to come into contact with the photocurable resin “D800”. The resin is irradiated with light so as to be cured in this state, and then the cover glass and the tube are removed, so that a cylindrical resin of which the toner is embedded in the uppermost surface is formed.

The cylindrical resin is cut by a length of a radius (4.0 μm, for example, in a case where a weight average particle diameter (D4) is 8.0 μm) from the outermost surface thereof at a cutting speed of 0.6 mm/s by using an Ultra Microtome (Leica Corporation, UC7), and a section of a toner central portion is exposed.

Next, the section of the toner is cut such that a film thickness is 100 nm, and thus a thin piece sample thereof is manufactured. In the above-described way, the section of the toner central portion is obtained.

An image may be acquired by using the STEM, for example, under the following conditions.
Probe size of STEM: 1 nm
Image size: 1024×1024 pixels
Detector control panel of bright-field panel
   Contrast: 1425
   Brightness: 3750
Image Control panel
   Contrast: 0.0
   Brightness: 0.5
   Gamma: 1.00
Image magnification: 100,000

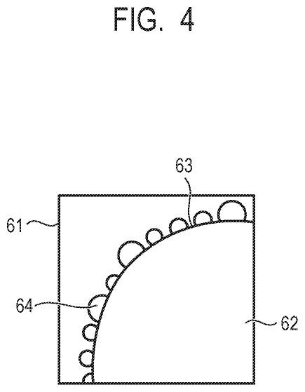

A STEM image 61 is acquired to include about ¼ of an outer circumference 63 of a spherical portion 62 of the toner in a section of a toner 1 particle, for example, as illustrated in FIG. 4. The STEM image 61 is preferably acquired to include about ¼ to ½ of the outer circumference 63 of the spherical portion 62 of the toner in the section of the toner.

Image analysis may be performed on the obtained STEM image 61 by using, for example, image processing software (Image J), and thus the projection portion including the organosilicon polymer may be measured. The image analysis may be performed on, for example, thirty locations of the STEM image 61.

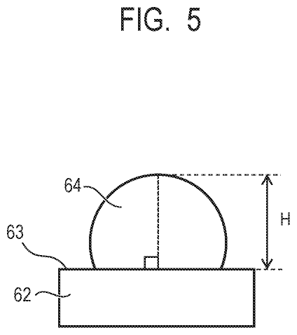

The image analysis may be performed as follows, for example. First, a line is drawn along the outer circumference 63 of the spherical portion 62 of the toner in a line drawing tool. Subsequently, the image is converted such that the drawn curved line is converted into a straight line. In this case, the conversion is performed such that a distance from the center of the sphere forming the spherical portion 62 of the toner to a surface of a projection-shaped organosilicon polymer 64 is not changed. Thereafter, with respect to each projection-shaped organosilicon polymer 64, for example, as illustrated in FIG. 5, the longest distance from the line 24 converted into the straight line of the projection-shaped organosilicon polymer 64 is measured to be set as a projection height H of the organosilicon polymer 64 in the converted image (refer to FIG. 5).

<Intermediate Transfer Body>

In the intermediate transfer body according to the present aspect, as described above, the hardness of the surface of the intermediate transfer body is 50 or more to 100 or less (N/mm²) in terms of universal hardness value (HU). According to our examination, if the hardness of the surface of the intermediate transfer body is less than 50 (N/mm²) in terms of universal hardness value (HU), an effect of reducing a discharge product attached to an electrophotographic photoreceptor surface. If the hardness of the surface of the intermediate transfer body is more than 100 (N/mm²), there is a high probability that damage may occur on the electrophotographic photoreceptor surface.

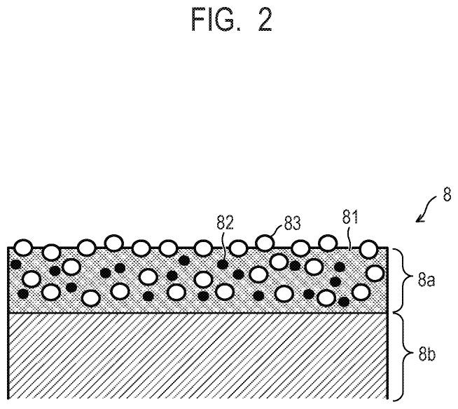

Next, the intermediate transfer body 8 will be further described. FIG. 2 is a schematic sectional view illustrating a layer configuration of the intermediate transfer body 8.

The intermediate transfer body 8 includes a base layer 8b and a surface layer 8a. In the present aspect, the intermediate transfer body 8 is formed of two layers such as the base layer 8b, and the surface layer 8a formed on the base layer 8b. The surface layer 8a is a layer provided further toward an outer circumferential surface side of the intermediate transfer body 8 than the base layer 8b, and is a layer having a surface carrying (holding) toner transferred from the electrophotographic photoreceptor 1. The intermediate transfer body 8 preferably has an endless belt shape, preferably has a thickness of 10 μm or more to 500 μm or less, and particularly preferably has a thickness of 40 μm or more to 100 μm or less.

Examples of a material forming the base layer 8b may include thermoplastic resins such as polycarbonate, polyvinylidene fluoride (PVDF), polyethylene, polypropylene, poly-4-methylpentene-1, polystyrene, polyamide, polysulfone, polyarylate, polyethylene terephthalate, polybutylene terephthalate, polyethylene naphthalate, polybutylene naphthalate, polyphenylene sulfide, polyether sulfone, polyether nitrile, thermoplastic polyimide, polyether ether ketone, thermotropic liquid crystal polymer, and polyamic acid. These may be used in combination of two or more kinds thereof.

The intermediate transfer body having the base layer 8b and an endless belt shape may be obtained by melting and mixing a conductive material or the like in these thermoplastic resins, and then by molding the mixture by using an appropriately selected molding method such as inflation molding, cylindrical extrusion molding, and injection stretch blow molding.

A material forming the surface layer 8a includes, as a binder material, a curable resin 81 which is cured due to irradiation with heat or light (ultraviolet ray), or an energy ray such as an electron ray. As the curable resin 81, an acrylic resin obtained by curing an unsaturated double bond-containing acrylic copolymer is preferably used, and, for example, an ultraviolet curable acrylic resin (product name: OPSTAR Z7501) manufactured by JSR Corporation may be used. The surface layer 8a contains the acrylic resin as a main component of the binder material. Here, the main component indicates that a content thereof is 50% by mass with respect to a binder material forming the surface layer 8a.

A conductive material 82 for adjusting electric resistance is added to the surface layer 8a. As the conductive material 82, for example, a conductive filler or an electric resistance adjuster made of an electron conductive material or an ion conductive material may be used. Examples of the electron conductive material may include particulate, fibrous, or flake-like carbon conductive fillers such as carbon black, PAN carbon fibers, and expanded graphite products. Examples of the electron conductive material may include particulate, fibrous, or flake-like metal conductive fillers such as silver, nickel, copper, zinc, aluminum, stainless steel, and iron. Examples of the electron conductive material may include particulate metal oxide conductive fillers such as zinc antimonate, antimony-doped tin oxide, antimony-doped zinc oxide, tin-doped indium oxide, and aluminum-doped zinc oxide. Examples of the ion conductive material may include electric resistance adjustors such as an ionic liquid, a conductive oligomer, and quaternary ammonium salt. As the conductive material 82, one or more materials may be selected and used as appropriate from among the materials, and the electron conductive material and the ion conductive material may be used in combination thereof. Above all, the particulate (preferably, a particle having a size of sub-micron or less) metal oxide conductive fillers are preferably used as the conductive material 82 in that an addition amount thereof is small.

A surface layer particle 83 may be added to the surface layer 8a in order to improve the transfer efficiency or to reduce friction with a belt cleaning blade 21. The surface layer particle 83 is preferably a solid lubricant, and is typically an insulating particle. Examples of the surface layer particle 83 may include fluorine-containing particles such as polytetrafluoroethylene (PTFE) resin powder, trifluorochlorinated ethylene resin powder, tetrafluoroethylene hexafluoropropylene resin powder, vinyl fluoride resin powder, vinylidene fluoride resin powder, difluoride chlorinated ethylene resin powder, and fluorinated graphite, and copolymers thereof. As the surface layer particle 83, one or more materials may be selected and used as appropriate from among the materials. The surface layer particle 83 may be a solid lubricant such as a silicone resin particle, a silica particle, or molybdenum disulfide powder. Above all, a polytetrafluoroethylene (PTFE) resin particle (for example, emulsion polymerization PTFE resin particles) is preferably used in that a friction coefficient of a particle surface is low, and wearing of other members in contact with the surface of the intermediate transfer body 8, the belt cleaning blade 21 can be reduced.

A description will be made of an example of a schematic method of manufacturing the surface layer 8a. The conductive material 82 and the surface layer particles 83 are mixed in an unsaturated double bond-containing acrylic copolymer, and are dispersed and mixed by an emulsifying dispersing machine such that a coating liquid for surface layer formation is produced. Examples of a method of forming the surface layer 8a on the base layer 8b by using the coating liquid for surface layer formation may include typical coating methods, for example, dip coating, spray coating, roll coating, and spin coating. The surface layer 8a having a desired film thickness may be obtained by using a method which is selected as appropriate from among the methods. In the coating liquid for surface layer formation, an organic solvent such as methyl ethyl ketone may be used as a solvent.

A volume resistivity of the intermediate transfer body 8 is preferably in the range of 1×10⁹ Ω·cm or more to 1×10¹² Ω·cm or less in that a favorable image is formed. The volume resistivity may be measured through measurement at a temperature of 23.5° C. and under the environment of the relative humidity of 60% by using Hiresta-UP MCP-HT450 (manufactured by Mitsubishi Chemical Corporation) which is a general purpose measurement instrument.

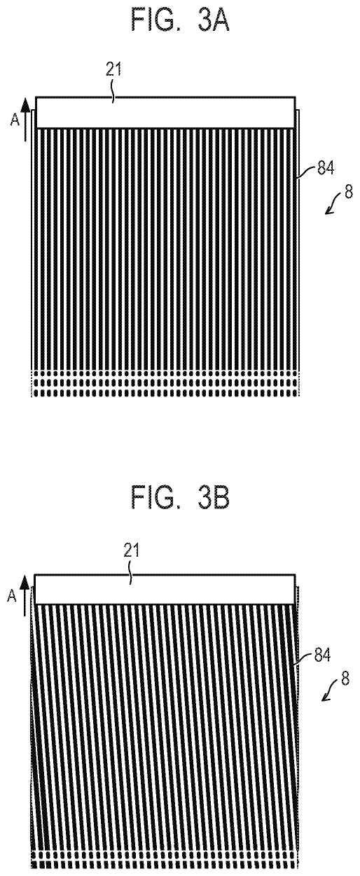

The surface layer 8a may be subjected to surface finishing treatment. FIG. 3A illustrates an example in which grooves 84 are formed in parallel to an arrow A indicating a rotation direction (circumferential direction) of the intermediate transfer body 8. That is, the grooves 84 are elongated in a circumferential direction of the endless shaped intermediate transfer body 8. As will be described later, even in a case where the grooves 84 are not formed in the surface layer 8a of the intermediate transfer body 8, a circumferential velocity difference is provided between the electrophotographic photoreceptor 1 and the intermediate transfer body 8, and thus it is possible to suppress a discharge product from being attached to the surface of the electrophotographic photoreceptor 1. However, in a case where the grooves 84 are formed, force of the cleaning blade 21 scraping an attachment on the intermediate transfer body 8 is improved, and thus it is possible to further suppress a discharge product from being attached to the surface of the electrophotographic photoreceptor 1.

A width of the groove 84 is preferably 2 μm, and a depth (a depth from an opening part of the groove 84 to the bottom in the thickness direction of the intermediate transfer body 8) thereof is preferably 1 μm. The groove 84 does not reach the base layer 8b, and is present only in the surface layer 8a. A pitch of the grooves 84 (an interval between the grooves 84 in a direction substantially orthogonal to the circumferential direction) is 10 μM or more to 100 μM or less, and is more preferably 10 μM or more to 20 μm or less. If the pitch of the grooves 84 is within the range, the grooves 84 may be formed at an identical interval, may be formed at random, and may not necessarily be formed in a periodic manner. The groove 84 may be continuously formed in the entire region along the circumferential direction of the intermediate transfer body 8, and may be intermittently formed. The groove 84 may not be formed linearly as a whole, may be bent or curved in the middle, and may be curved as a whole.

The grooves 84 are formed on the surface of the surface layer 8a through surface finishing treatment in which a wrapping film as shaping means is brought into contact with the surface layer 8a of the intermediate transfer body 8 rotated in the circumferential direction. As illustrated in FIG. 3B, the grooves 84 may be formed in a spiral shape by bringing the wrapping film into contact with the surface layer 8a while gradually moving the wrapping film in a direction perpendicular to the circumferential direction of the intermediate transfer body 8. In a case where the groove 84 is formed in a spiral shape, the groove 84 has an angle with respect to the circumferential direction of the intermediate transfer body 8, and thus the scraping force of the cleaning blade 21 is further improved. Thus, it is possible to further suppress a discharge product from being attached to the surface of the electrophotographic photoreceptor 1. An angle of the groove 84 formed with the circumferential direction of the intermediate transfer body 8 is preferably over 0° to ±45° or less.

<Image Forming Method>

In the image forming method according to the present aspect, a velocity difference (circumferential velocity difference) dVn is provided between a circumferential velocity of the electrophotographic photoreceptor 1 and a circumferential velocity of the intermediate transfer body 8, and thus a discharge product is hardly attached to the surface of the electrophotographic photoreceptor 1, and is easily removed even in a case where the disparity is attached.

In the present embodiment, the circumferential velocity difference dVn may be provided such that the circumferential velocity of the electrophotographic photoreceptor 1 is lower than the circumferential velocity of the intermediate transfer body 8. In a case where the circumferential velocity difference dVn is provided such that the circumferential velocity of the electrophotographic photoreceptor 1 is higher than the circumferential velocity of the intermediate transfer body 8, an effect of further suppressing a discharge product from being attached to the surface of the electrophotographic photoreceptor 1 is achieved. The circumferential velocity difference dVn is a value obtained according to the following Equation (1).

dVn={(circumferential velocity of intermediate transfer body-circumferential velocity of electrophotographic photoreceptor)/circumferential velocity of intermediate transfer body}×100[%] (1)

In a case where the circumferential velocity difference dVn is 5% or less, and is more preferably 3% or less, favorable primary transfer of a toner image can be performed, and thus image quality deterioration can be prevented. The circumferential velocity difference dVn may be set to be wider than the range since image quality deterioration is not influenced except for the time of forming an image. In other words, the circumferential velocity difference dVn may be set to a value greater than 5%. Here, dVn greater than 5% is defined as a circumferential velocity difference dVs in a special image forming mode. A timing of executing the special image forming mode for providing the circumferential velocity difference dVs may be the time of so-called post-rotation right after an image is formed, or the time at which an image defect occurs due to attachment of a discharge product to the surface of the electrophotographic photoreceptor 1. The special image forming mode may be performed at a timing which is set in advance in the image forming apparatus, and may be selected from an operation panel by a user, according to ambient environmental conditions of the image forming apparatus or usage conditions such as the number of printed sheets using the image forming apparatus.

As described above, according to the present aspect, it is possible to suppress deterioration in developing property, and also to suppress a discharge product from being attached to the surface of the electrophotographic photoreceptor without damaging the surface of the electrophotographic photoreceptor.

### EXAMPLES

Hereinafter, the present aspect will be described in detail by using Examples. In Examples and comparative examples, “parts” and “%” are all based on mass unless otherwise mentioned.

<Manufacturing of Toner 1>

(Preparation Step of Aqueous Medium 1)

14.0 parts of sodium phosphate (manufactured by Rasa Industries, LTD., 12-hydrate) was put into 1000.0 parts of ion-exchanged water in a reaction vessel, and was warmed for an hour at 65° C. while performing nitrogen purge.

This was stirred at 12000 rpm by using T.K. Homomixer (manufactured by Tokushu Kika Kogyo Co., Ltd.), and a calcium chloride aqueous solution containing 9.2 parts of calcium chloride (dihydrate) dissolved in 10.0 parts of ion-exchanged water was collectively put thereinto, so that an aqueous medium containing a dispersion stabilizer was prepared. A 10 mass % hydrochloric acid was put into the aqueous medium such that pH thereof was adjusted to 6.0, and thus the aqueous medium 1 was obtained.

(Preparation Step of Polymerizable Monomer Composition)

Styrene: 60.0 parts

C.I. Pigment Blue 15:3: 6.5 parts

The materials were put into an attritor (manufactured by Mitsui Miike Kakoki Co., Ltd.), and were further dispersed at 220 rpm for 5.0 hours by using zirconia particles each having a diameter of 1.7 mm such that a pigment dispersion liquid was prepared.

The following materials were added to the pigment dispersion liquid.

Styrene: 20.0 parts

n-butyl acrylate: 20.0 parts

Crosslinking agent, divinylbenzene: 0.3 parts

Saturated polyester resin: 5.0 parts

(polycondensate of propylene oxide-modified bisphenol A (2 molar adduct) and terephthalic acid (molar ratio 10:12), glass transition temperature Tg=68° C., weight average molecular weight Mw=10000, and molecular weight distribution Mw/Mn=5.12)

Fischer Tropsch wax (melting point 78° C.): 7.0 parts

These were warmed at 65° C., and were uniformly dissolved and dispersed at 500 rpm by using T.K. Homomixer (manufactured by Tokushu Kika Kogyo Co., Ltd.) such that a polymerizable monomer composition was prepared.

(Hydrolysis Step of Organosilicon Compound for Surface Layer)

In a reaction vessel equipped with a stirrer and a thermometer, 60.0 parts of ion-exchanged water was weighed, and pH was adjusted to 3.0 by using a 10 wt % hydrochloric acid. This was stirred and heated, and a temperature was 70° C. Thereafter, 40.0 parts of methyltriethoxysilane was added, and was stirred for two hours, and the organosilicon compound for surface layer was hydrolyzed. It was visually checked at the end point of the hydrolysis that oil and water are not separated in a single layer, and cooling was performed to obtain a hydrolyzed liquid of the organosilicon compound for surface layer.

(Granulation Step)

A temperature of the aqueous medium 1 was set to 70° C., and a rotational speed of a stirring device was maintained at 12000 rpm. In this state, a polymerizable monomer composition was put into the aqueous medium 1, and 9.0 parts of t-butyl peroxy pivalate which is a polymerization initiator was added thereto. In this state, granulation was performed for ten minutes while the stirring device was maintained at 12000 rpm.

(Polymerization Step)

The high-speed stirring device was replaced with a propeller stirring blade as a stirrer, stirring was performed at 150 rpm, 70° C. was held, and polymerization was performed for 5.0 hours. The temperature was increased to 85° C., heating was performed for 2.0 hours such that a polymerization reaction was performed, and thus slurry of toner particles was obtained. Thereafter, a temperature of the slurry was decreased to 70° C., and pH was measured to be 5.0. 20.0 parts of the hydrolyzed solution of the organosilicon compound for surface layer was added while stirring was continuously performed at 70° C., and a surface layer of a toner particle was formed. After the slurry was held for 90 minutes in this state, pH of the slurry was adjusted to 9.0 by using a sodium hydroxide aqueous solution in order to complete condensation of the organosilicon compound, and the slurry was further held for 300 minutes such that a surface layer was formed.

(Cleaning and Drying Steps)

After the polymerization step was finished, the slurry of toner particles was cooled, and was added with a hydrochloric acid such that pH of the slurry was adjusted to 1.5 or lower. After stirring for an hour, the slurry was subjected to solid-liquid separation in a pressure filter, and thus a toner cake was obtained. The toner cake was added with ion-exchanged water so as to produce re-slurry, and a dispersion liquid was obtained again, and was then subjected to solid-liquid separation in the filter. Producing of re-slurry and solid-liquid separation were repeatedly performed until electric conductivity of the filtrate became 5.0 μS/cm or less, and solid-liquid separation was finally performed such that a toner cake was performed. The obtained toner cake was dried in a flash drier (product name: Flash Jet Drier, manufactured by Seishin Enterprise Co., Ltd.), and then coarse particles were cut by using a multi-division classifier using the Coanda effect such that the toner particles 1 were obtained. Regarding drying conditions, a blowing temperature was 90° C., a dryer outlet temperature was 40° C., and a toner cake supply rate was adjusted such that the outlet temperature was not deviated from 40° C. according to a moisture content of the toner cake. In section observation of the toner particle 1 using a TEM, silicon mapping was performed, and it was checked that uniform Si atoms were present in the surface layer, and a proportion of the number of division axes in which a thickness of the surface layer of the toner particle containing the organosilicon polymer was 2.5 nm or less was 20.0% or less. Also in the subsequent Examples and comparative examples, silicon mapping was performed on the surface layer containing the organosilicon polymer, and it was checked that uniform Si atoms were present in the surface layer, and a proportion of the number of division axes in which a thickness of the surface layer was 2.5 nm or less was 20.0% or less. In evaluation of the image forming apparatus, the obtained toner particles 1 were used as the toner 1 without external addition.

<Manufacturing of Toner 2 to 16, and Comparative Toner 1 to 3>

In manufacturing of the toner 1, each of a condition of adding a hydrolyzed liquid and a time to hold the hydrolyzed liquid was changed as illustrated in Table 1. The toner 2 to 16 and the comparative toner 1 to 3 were manufactured in a state in which the rest were the same as in the toner 1.

<Manufacturing of Toner 17>

In manufacturing of the toner 1, each of a condition of adding a hydrolyzed liquid and a time to hold the hydrolyzed liquid was changed as illustrated in Table 1. The toner was manufactured in a state in which the rest were the same as in the toner 1. 0.2 parts of strontium titanate was weighed with respect to 100 g of the toner, and was added to the obtained toner as an external additive. These were put into SUPERMIXER PICCOLO SMP-2 (manufactured by Kawata MFG. Co., Ltd.), and are mixed with each other at 3000 rpm for 10 minutes such that the toner 17 was obtained.

TABLE 1

| | | | | Condition after |
|---|---|---|---|---|
| | Condition of adding | | | addition |
| | hydrolyzed liquid | | | Holding time |
| | Number | | | until pH |
| | of parts of | | | is adjusted for |
| | added | | | completion of |
| | hydrolyzed | | Temperature | condensation |
| | liquid | pH | (° C.) | (min) |
| Toner 1 | 20 | 5.0 | 70 | 90 |
| Toner 2 | 40 | 5.0 | 55 | 0 |
| Toner 3 | 3 | 6.5 | 75 | 0 |
| Toner 4 | 5 | 6.5 | 80 | 0 |
| Toner 5 | 37 | 5.0 | 55 | 0 |
| Toner 6 | 20 | 5.0 | 65 | 0 |
| Toner 7 | 37 | 5.0 | 55 | 0 |
| Toner 8 | 12 | 6.0 | 65 | 0 |
| Toner 9 | 38 | 5.0 | 55 | 0 |
| Toner 10 | 12 | 5.5 | 80 | 30 |
| Toner 11 | 12 | 5.0 | 55 | 30 |
| Toner 12 | 11 | 5.5 | 60 | 30 |
| Toner 13 | 4 | 6.5 | 60 | 0 |
| Toner 14 | 37 | 5.0 | 70 | 0 |
| Toner 15 | 22 | 5.0 | 60 | 90 |
| Toner 16 | 5 | 6.0 | 70 | 90 |
| Toner 17 | 12 | 5.5 | 60 | 30 |
| Comparative toner 1 | 11 | 5.5 | 85 | 15 |
| Comparative toner 2 | 3 | 7.0 | 85 | 0 |
| Comparative toner 3 | 40 | 5.0 | 85 | 0 |
| Comparative toner 4 | — | — | — | — |

[Evaluation of Toner Particle and Toner]

With respect to the toner particles and the toner obtained in the above-described way, a sticking ratio of the organosilicon polymer to the toner base, a content of the organosilicon polymer in the toner particle, a projection height of the organosilicon polymer in the toner particle, and the Martens hardness of the toner were measured according to the above-described methods. Evaluation results are shown in Table 2.

TABLE 2

| | Organosilicon | | Organosilicon | Martens |
|---|---|---|---|---|
| | polymer | Organosilicon | polymer | Hard- |
| | Sticking | polymer | Projection | ness |
| | ratio (%) | Content (%) | height (nm) | (MPa) |
| Toner 1 | 85.2 | 0.4 | 25 | 168 |
| Toner 2 | 95.5 | 5.2 | 108 | 185 |
| Toner 3 | 91.2 | 0.4 | 27 | 155 |
| Toner 4 | 86.3 | 0.6 | 43 | 171 |
| Toner 5 | 93.6 | 4.8 | 97 | 190 |
| Toner 6 | 92.5 | 2.6 | 62 | 179 |
| Toner 7 | 96.5 | 4.7 | 98 | 181 |
| Toner 8 | 91.1 | 1.6 | 72 | 166 |
| Toner 9 | 94.5 | 4.9 | 99 | 182 |
| Toner 10 | 85.5 | 1.6 | 61 | 598 |
| Toner 11 | 98.7 | 1.6 | 55 | 550 |
| Toner 12 | 93.1 | 1.4 | 58 | 542 |
| Toner 13 | 93.1 | 0.5 | 43 | 203 |
| Toner 14 | 92.5 | 4.8 | 75 | 203 |
| Toner 15 | 93.2 | 2.8 | 97 | 1092 |
| Toner 16 | 92.4 | 0.7 | 44 | 1092 |
| Toner 17 | 93.1 | 1.6 | 61 | 590 |
| Comparative | 84.1 | 1.4 | 52 | 368 |
| toner 1 | | | | |
| Comparative | 84.3 | 0.4 | 27 | 182 |
| toner 2 | | | | |
| Comparative | 84.2 | 5.2 | 107 | 177 |
| toner 3 | | | | |
| Comparative | — | — | — | 107 |
| toner 4 | | | | |

<Manufacturing of Electrophotographic Photoreceptor 1>

An aluminum cylinder (JIS-A3003, aluminum alloy) having a diameter of 24 mm and a length of 257.5 mm was used as a supporting member (conductive supporting member).

(Formation of Conductive Layer)

Next, the following materials were prepared.
Titanium oxide (TiO₂) particles (average primary particle diameter of 230 nm) coated with oxygen deficient tin oxide (SnO₂) as metal oxide particles: 214 parts
Phenolic resin (monomer/oligomer of phenolic resin) (brand name: plyophene J-325, manufactured by Dainippon Ink and Chemicals, Inc., resin solid content: 60% by mass) as a binder resin: 132 parts
1-Methoxy-2-propanol as solvent: 98 parts
Glass beads with diameter of 0.8 mm: 450 parts

These materials were placed in a sand mill, and dispersion treatment was performed under conditions of a rotational speed of 2000 rpm, dispersion treatment time of 4.5 hours, and a cooling water setting temperature of 18° C., and thus a dispersion liquid was obtained.

The glass beads were removed from the dispersion liquid with a mesh (mesh size: 150 μm). Subsequently, a silicone resin particle (product name: Tospearl 120, manufactured by Momentive Performance Materials Corporation; average particle diameter 2 μm) as a surface roughening material was added to the dispersion liquid. An amount of the added silicone resin particles was 10% by mass with respect to the total mass of the metal oxide particles and the binder resin in the dispersion liquid from which the glass beads were removed. A silicone oil (product name: SH28PA, manufactured by Dow Corning Toray Co., Ltd.) as a leveling agent was added to the dispersion liquid such that an amount thereof was 0.01% by mass with respect to the total mass of the metal oxide particles and the binder resin. Next, a mixed solvent of methanol and 1-methoxy-2-propanol (mass ratio 1:1) was added to the dispersion liquid and was stirred such that a coating liquid for conductive layer was prepared. The mixed solvent was added such that the total mass (that is, the mass of solid contents) of the metal oxide particles, the binder material, and the surface roughening material was 67% by mass with respect to the mass of the dispersion liquid. The supporting member was dip-coated with the coating liquid for conductive layer, and the coating liquid was heated at 150° C. for 30 minutes to form a conductive layer having a thickness of 30.0 μm.

(Formation of Under Coating Layer)

The following materials were prepared.
Electron transport material represented by the following Formula (E): 4 parts
Blocked isocyanate (product name: Duranate SBN-70D, manufactured by Asahi Kasei Chemicals Corporation): 5.5 parts
Polyvinyl butyral resin (S-LEC KS-5Z, manufactured by Sekisui Chemical Co., Ltd.): 0.3 parts
Hexanate zinc (II) as catalyst (Mitsuwa Chemicals Co., Ltd.): 0.05 parts

These materials were dissolved in a mixed solvent of 50 parts of tetrahydrofuran and 50 parts of 1-methoxy-2-propanol to prepare a coating liquid for under coating layer. The conductive layer was dip-coated with the coating liquid for under coating layer, and the coating liquid was heated at 170° C. for 30 minutes to form an under coating layer having a thickness of 0.7 μm.

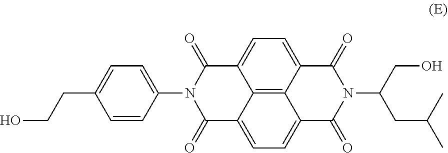 [SMILES: CC(C)CC(CO)N1C(=O)c2ccc3c4c(ccc(c24)C1=O)C(=O)N(c1ccc(CCO)cc1)C3=O]

(Formation of Charge Generating Layer)

Next, 10 parts of hydroxygallium phthalocyanine in a crystalline form and 5 parts of polyvinyl butyral resin (product name: S-LEK BX-1, manufactured by Sekisui Chemical Co., Ltd.) having peaks at 7.5° and 28.4° in a chart obtained on the basis of CuKα characteristic X-ray diffraction were added to 200 parts of cyclohexanone, and were dispersed for 6 hours with a sand mill device using glass beads each having a diameter of 0.9 mm. This was further added with 150 parts of cyclohexanone and 350 parts of ethyl acetate so as to be diluted, and thus a coating liquid for charge generating layer was obtained. The under coating layer was dip-coated with the obtained coating liquid for charge generating layer, and the coating liquid was dried at 95° C. for 10 minutes to form a charge generating layer having a film thickness of 0.20 X-ray diffraction measurement was performed under the following conditions.

[Powder X-Ray Diffraction Measurement]

Measuring instrument used: X-ray diffraction device RINT-TTR II manufactured by Rigaku Corporation.

X-ray tube: Cu

Tube voltage: 50 KV

Tube current: 300 mA

Scanning method: 2θ/θ scanning

Scanning speed: 4.0°/min

Sampling interval: 0.02°

Start angle (2θ): 5.0°

Stop angle (2θ): 40.0°

Attachment: standard sample holder

Filter: not used

Incident monochrome: used

Counter monochrometor: not used

Divergence slit: opened

Vertical divergence limitation slit: 10.00 mm

Scattering slit: opened

Light receiving slit: opened

Flat monochrometer: used

Counter: scintillation counter

(Formation of Charge Transport Layer)

Next, the following materials were prepared.
Compound (charge transport material (hole transport compound)) expressed in the following Formula (C-1): 6 parts
Compound (charge transport material (hole transport compound)) expressed in the following Formula (C-2): 3 parts
Compound (charge transport material (hole transport compound)) expressed in the following Formula (C-3): 1 part
Polycarbonate (product name: lupilon Z400, manufactured by Mitsubishi Engineering Plastics Co., Ltd.): 10 parts
Polycarbonate resin having copolymer unit of (C-4) and (C-5): 0.02 parts (x/y=9/1: Mw=20000)

These were dissolved in a mixed solvent of 25 parts of o-xylene/25 parts of methyl benzoate/25 parts of dimethoxymethane to prepare a coating liquid for charge transport layer. The charge generating layer was dip-coated with the coating liquid for charge transport layer, and the coating liquid was dried at 120° C. for 30 minutes to form a charge transport layer having a film thickness of 12 μm.

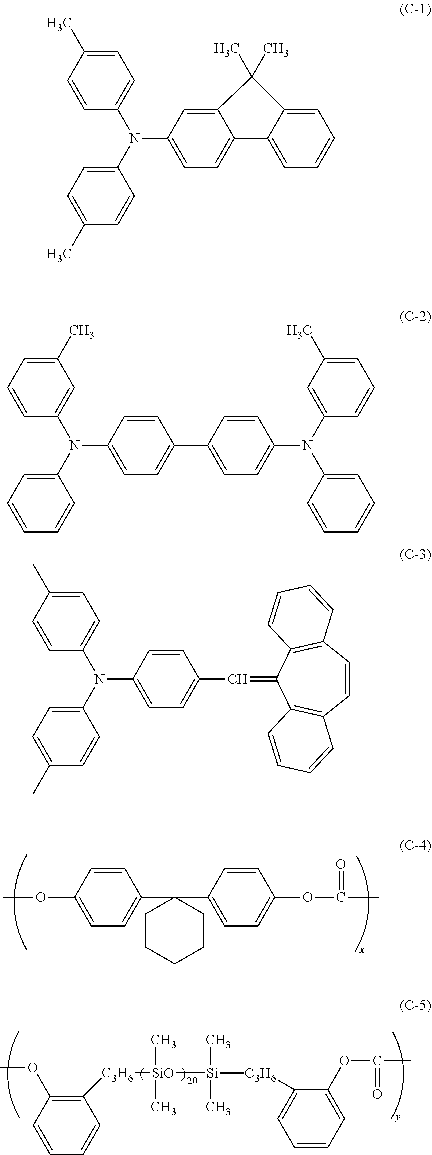

(Formation of Surface Layer)

The following materials were prepared.
Compound represented by the following Formula (A-12): 10 parts
Compound represented by the following Formula (A-25): 10 parts
1-propanol: 25 parts
Cyclohexane: 50 parts

These materials were mixed and stirred. Thereafter, this solution was filtered with a polychlorofluorocarbon filter (product name: PF-020, manufactured by Advantec Toyo Roshi Kaisha, Ltd.) to prepare a coating liquid for protective layer.

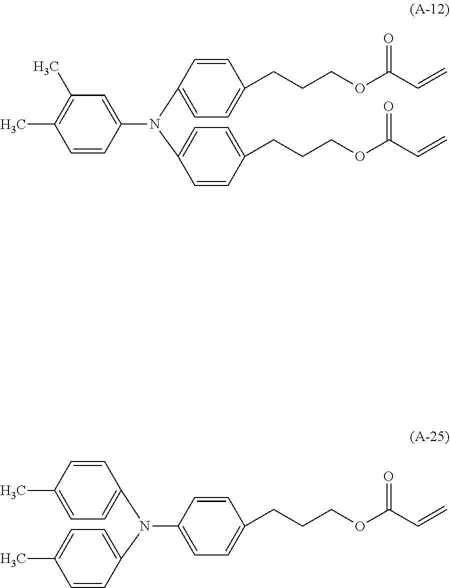

The charge transport layer was dip-coated with the controller for surface layer such that a coating film was formed, and the coating film was dried at 50° C. for 6 minutes. Thereafter, the coating film was irradiated with electron beams for 1.6 seconds while the supporting member (irradiated member) was rotated at a speed of 200 rpm under a nitrogen atmosphere and under conditions of an acceleration voltage of 70 kV and a beam current of 5.0 mA. An absorbed dose of the electron beams measured at this time was 15 kGy. Thereafter, the coating film was heated for 30 seconds until the temperature of the coating film reaches 117° C. from 25° C. An oxygen concentration from the electron beam irradiation to the subsequent heating treatment was 15 ppm or less. Next, the coating film was naturally cooled until the temperature thereof reaches 25° C. in the air, and was heated for 30 minutes until the temperature thereof reaches 105° C., so that a surface layer as a protective layer having a film thickness of 3 μm was formed. In the above-described way, the electrophotographic photoreceptor having the surface layer was manufactured. In the above-described way, the cylindrical (drum-shaped) electrophotographic photoreceptor 1 having the supporting member, the under coating layer, the charge generating layer, the charge transport layer, and the surface layer in this order was manufactured.

<Manufacturing of Electrophotographic Photoreceptors 2 and 3>

In manufacturing of the electrophotographic photoreceptor 1, an acceleration voltage and an electron beam irradiation time during formation of a protective layer were changed as shown in Table 3. The electrophotographic photoreceptors 2 and 3 were manufactured in a state in which the rest were the same as in the electrophotographic photoreceptor 1.

<Manufacturing of Electrophotographic Photoreceptor 4>

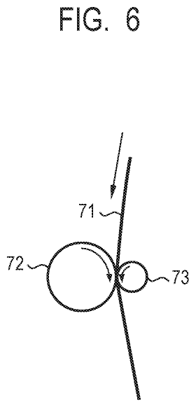

In manufacturing of the electrophotographic photoreceptor 1, after the protective layer was formed, the surface of the electrophotographic photoreceptor was polished by using a polishing device illustrated in FIG. 6, and was roughened.

In FIG. 6, a polishing sheet 71 is wound in an arrow direction by a winding mechanism (not illustrated). An electrophotographic photoreceptor 72 is rotated in an arrow direction. A backup roller 73 is rotated in an arrow direction.

As the polishing sheet 71, a polishing sheet (product name: GC#3000, base layer sheet thickness: 75 μm) manufactured by Riken Corundum Co., Ltd. was used. As the backup roller 73, a urethane roller (outer diameter: 50 mm) having a hardness of 20° was used. Polishing was performed for 10 seconds in a state in which the feeding direction of the polishing sheet and the rotation direction of the electrophotographic photoreceptor are the same as each other under polishing conditions of an intrusion amount of 2.5 mm and a sheet feed amount of 400 mm/s. In the above-described way, the electrophotographic photoreceptor 4 was manufactured.

<Manufacturing of Electrophotographic Photoreceptors 5 to 7 and 10 to 15>

In manufacturing of the electrophotographic photoreceptor 4, an acceleration voltage and an electron beam irradiation time during formation of a protective layer and a polishing time during formation of the protective layer were changed as shown in Table 3. Photoreceptors 11 and 13 were changed to compounds shown in Table 2. The electrophotographic photoreceptors 5 to 7 were manufactured in a state in which the rest were the same as in the electrophotographic photoreceptor 4.

<Manufacturing of Electrophotographic Photoreceptor 8>

In manufacturing of the electrophotographic photoreceptor 1, compounds used to form a protective layer were changed to 8.2 parts of the compound represented by the above Formula (A-12), 1.8 parts of the compound represented by the above Formula (A-25), and 12 parts of a compound represented by the following Formula (0-1) not having a charge transport function. The electrophotographic photoreceptor 8 was manufactured in a state in which the rest were the same as in the electrophotographic photoreceptor 1.

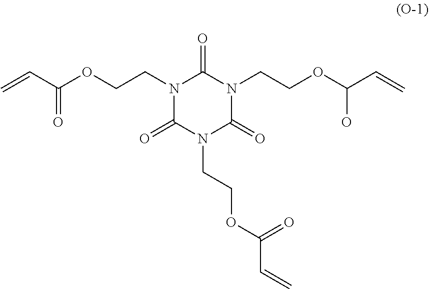 [SMILES: C=CC(=O)OCCn1c(=O)n(CCOC(=O)C=C)c(=O)n(CCOC(O)C=C)c1=O]

<Manufacturing of Electrophotographic Photoreceptor 9>

In manufacturing of the electrophotographic photoreceptor 1, compounds used to form a protective layer were changed to 2.5 parts of the compound represented by the above Formula (A-12), 7.5 parts of the compound represented by the above Formula (A-25), and 12 parts of a compound represented by the above Formula (0-1) not having a charge transport function. An acceleration voltage during formation of a protective layer was changed as shown in Table 3. The electrophotographic photoreceptor 9 was manufactured in a state in which the rest were the same as in the electrophotographic photoreceptor 1.

<Manufacturing of Electrophotographic Photoreceptor 16>

In manufacturing of the electrophotographic photoreceptor 4, compounds used to form a protective layer were changed to 7 parts of the compound represented by the above Formula (A-12), and 13 parts of the compound represented by the above Formula (A-25). An acceleration voltage and an electron beam irradiation time during formation of a protective layer and a polishing time during formation of the protective layer were changed as shown in Table 3. The electrophotographic photoreceptor 16 was manufactured in a state in which the rest were the same as in the electrophotographic photoreceptor 4.

<Manufacturing of Electrophotographic Photoreceptor 17>

In manufacturing of the electrophotographic photoreceptor 8, an acceleration voltage during formation of a protective layer was changed as shown in Table 3. Roughening was performed in the same manner as in the electrophotographic photoreceptor 4 except that a polishing time was 15 seconds. The electrophotographic photoreceptor 17 was manufactured in a state in which the rest were the same as in the electrophotographic photoreceptor 8.

<Manufacturing of Electrophotographic Photoreceptor 18>

In manufacturing of the electrophotographic photoreceptor 9, an acceleration voltage during formation of a protective layer was changed as shown in Table 3. Roughening was performed in the same manner as in the electrophotographic photoreceptor 4 except that a polishing time was 55 seconds. The electrophotographic photoreceptor 18 was manufactured in a state in which the rest were the same as in the electrophotographic photoreceptor 9.

<Manufacturing of Comparative Electrophotographic Photoreceptor 1>

In manufacturing of the electrophotographic photoreceptor 1, materials used to prepare a coating liquid for protective layer were changed as follows.
Compound expressed in the following Formula (A-14): 20 parts
Polytetrafluoroethylene particles (product name: Lubron L-2, manufactured by Daikin Industries, Ltd.): 15 parts
1-propanol: 50 parts
1,1,2,2,3,3,4-heptafluorocyclopentane (product name: Zeorora H, manufactured by Zeon Corporation): 40 parts

These were placed in an ultrahigh pressure dispersing machine, and were dispersed and mixed such that a coating liquid or protective layer was adjusted. The comparative electrophotographic photoreceptor 1 was manufactured in a state in which the rest were the same as in the electrophotographic photoreceptor 1.

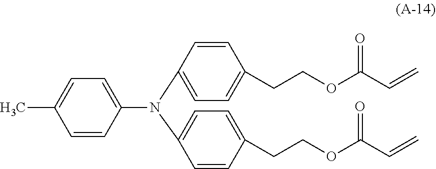 [SMILES: C=CC(=O)OCCc1ccc(N(c2ccc(C)cc2)c2ccc(CCOC(=O)C=C)cc2)cc1]

<Manufacturing of Comparative Electrophotographic Photoreceptor 2>

In manufacturing of the comparative electrophotographic photoreceptor 1, polytetrafluoroethylene particles were not used to prepare a coating liquid for protective layer. An acceleration voltage during formation of a protective layer was changed as shown in Table 3. The comparative electrophotographic photoreceptor 2 was manufactured in a state in which the rest were the same as in the comparative electrophotographic photoreceptor 1.

<Manufacturing of Comparative Electrophotographic Photoreceptor 3>

In manufacturing of the comparative electrophotographic photoreceptor 2, compounds used to form a protective layer were changed to 10 parts of the compound represented by the above Formula (A-14), and 10 parts of a compound represented by the following Formula (O-2) in the protective layer forming step of the comparative electrophotographic photoreceptor 2. The comparative electrophotographic photoreceptor 3 was manufactured in a state in which the rest were the same as in the comparative electrophotographic photoreceptor 2.

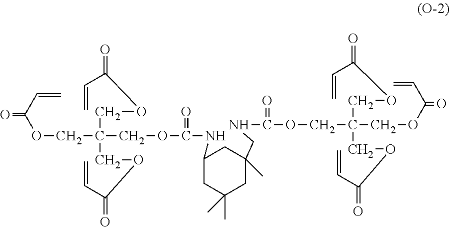 [SMILES: C=CC(=O)OCC(COC(=O)C=C)(COC(=O)C=C)COC(=O)NCC1(C)CC(NC(=O)OCC(COC(=O)C=C)(COC(=O)C=C)COC(=O)C=C)CC(C)(C)C1]

<Manufacturing of Comparative Electrophotographic Photoreceptor 4>

In manufacturing of the comparative electrophotographic photoreceptor 3, an acceleration voltage during formation of a protective layer was changed as shown in Table 3. Roughening was performed in the same manner as in the electrophotographic photoreceptor 4 except that a polishing time was 30 seconds. The comparative electrophotographic photoreceptor 4 was manufactured in a state in which the rest were the same as in the comparative electrophotographic photoreceptor 3.

<Manufacturing of Comparative Electrophotographic Photoreceptor 5>

In manufacturing of the electrophotographic photoreceptor 1, a protective layer was not formed. Roughening was performed in the same manner as in the electrophotographic photoreceptor 4 except that a polishing time was 30 seconds. The comparative electrophotographic photoreceptor 5 was manufactured in a state in which the rest were the same as in the electrophotographic photoreceptor 1.

TABLE 3

| | | | | | | | Accel- | | Irradi- | Pol- |
|---|---|---|---|---|---|---|---|---|---|---|
| | | | | | | | eration | Beam | ation | ishing |
| | | | | | | | voltage | current | time | time |
| | Compound used to form protective layer | | | | | | (kV) | (mA) | (s) | (s) |
| Electrophotographic photoreceptor 1 | (A-12) | 10 parts | (A-25) | 10 parts | — | | 60 | 5.0 | 1.6 | — |
| Electrophotographic photoreceptor 2 | (A-12) | 10 parts | (A-25) | 10 parts | — | | 70 | 5.0 | 5.0 | — |
| Electrophotographic photoreceptor 3 | (A-12) | 10 parts | (A-25) | 10 parts | — | | 70 | 5.0 | 1.6 | — |
| Electrophotographic photoreceptor 4 | (A-12) | 10 parts | (A-25) | 10 parts | — | | 60 | 5.0 | 1.6 | 5 |
| Electrophotographic photoreceptor 5 | (A-12) | 10 parts | (A-25) | 10 parts | — | | 70 | 5.0 | 5.0 | 5 |
| Electrophotographic photoreceptor 6 | (A-12) | 10 parts | (A-25) | 10 parts | — | | 60 | 5.0 | 1.6 | 60 |
| Electrophotographic photoreceptor 7 | (A-12) | 10 parts | (A-25) | 10 parts | — | | 70 | 5.0 | 5.0 | 60 |
| Electrophotographic photoreceptor 8 | (A-12) | 8.2 parts | (A-25) | 1.8 parts | (O-1) | 12 parts | 60 | 5.0 | 1.6 | — |
| Electrophotographic photoreceptor 9 | (A-12) | 2.5 parts | (A-25) | 7.5 parts | (O-1) | 12 parts | 70 | 5.0 | 1.6 | — |
| Electrophotographic photoreceptor 10 | (A-12) | 10 parts | (A-25) | 10 parts | — | | 70 | 5.0 | 1.6 | 30 |
| Electrophotographic photoreceptor 11 | (A-12) | 10 parts | (A-27) | 10 parts | — | | 70 | 5.0 | 1.6 | 15 |
| Electrophotographic photoreceptor 12 | (A-12) | 10 parts | (A-25) | 10 parts | — | | 70 | 5.0 | 1.6 | 55 |
| Electrophotographic photoreceptor 13 | (A-12) | 10 parts | (A-27) | 10 parts | — | | 60 | 5.0 | 1.6 | 10 |
| Electrophotographic photoreceptor 14 | (A-12) | 10 parts | (A-25) | 10 parts | — | | 70 | 5.0 | 5.0 | 60 |
| Electrophotographic photoreceptor 15 | (A-12) | 10 parts | (A-25) | 10 parts | — | | 60 | 5.0 | 1.6 | 50 |
| Electrophotographic photoreceptor 16 | (A-12) | 7 parts | (A-25) | 13 parts | — | | 65 | 5.0 | 2.3 | 10 |
| Electrophotographic photoreceptor 17 | (A-12) | 8.2 parts | (A-25) | 1.8 parts | (O-1) | 12 parts | 65 | 5.0 | 1.6 | 15 |
| Electrophotographic photoreceptor 18 | (A-12) | 2.5 parts | (A-25) | 7.5 parts | (O-1) | 12 parts | 65 | 5.0 | 1.6 | 55 |

| Comparative electrophotographic | (A-14) | 20 parts | 15 parts of | | — | 60 | 5.0 | 1.6 | — |
|---|---|---|---|---|---|---|---|---|---|
| photoreceptor 1 | | | polytetra- | | | | | | |
| | | | fluoroethylene | | | | | | |
| | | | particles | | | | | | |
| Comparative electrophotographic | (A-14) | 20 parts | — | | — | 70 | 5.0 | 1.6 | — |
| photoreceptor 2 | | | | | | | | | |
| Comparative electrophotographic | (A-14) | 10 parts | (O-2) | 10 parts | — | 70 | 5.0 | 1.6 | — |
| photoreceptor 3 | | | | | | | | | |
| Comparative electrophotographic | (A-14) | 10 parts | (O-2) | 10 parts | — | 70 | 5.0 | 1.6 | 30 |
| photoreceptor 4 | | | | | | | | | |

| | | | | | | | |
|---|---|---|---|---|---|---|---|
| Comparative electrophotographic | — | — | — | — | — | — | 20 |
| photoreceptor 5 | | | | | | | |

[Evaluation of Electrophotographic Photoreceptors]

With respect to the obtained electrophotographic photoreceptors, a hardness and a surface roughness of a surface of an electrophotographic photoreceptor were measured according to the following method. Evaluation results are shown in Table 4.

<Measurement of Hardness of Surface of Electrophotographic Photoreceptor>

The universal hardness value (HU) and the elastic deformation ratio were measured by using Fischerscope H100V (manufactured by Fischer Corporation) which is a fine hardness measuring device under the environment of 25° C./50% RH.

The measurement was performed under environmental measurement conditions of a temperature of 23° C. and a humidity of 50% RH by using a Fiscerscope (product name: H100VP-HCU, manufactured by Fischer Corporation). The Vickers square-pyramid diamond indenter having a facing angle of 136° was used as an indenter, the diamond indenter was pushed into a surface of a measurement target electrophotographic photoreceptor, a load was applied up to 2 mN for 7 seconds, and then a push depth was continuously measured until the load is gradually reduced to 0 mN for 7 seconds. The universal hardness value (HU) and the elastic deformation ratio (We) were obtained on the basis of a result thereof

<Measurement of Surface Roughness of Electrophotographic Photoreceptor>

A surface roughness of a surface layer of an electrophotographic photoreceptor after being polished was measured by using a surface roughness measuring machine (product name: SE700, SMB-9, manufactured by Kosaka Laboratory Ltd.) under the following conditions. The measurement was performed in terms of 10-point average roughness (Rzjis) measured through sweeping in a circumferential direction, and an average gap (RSm) measured through sweeping in the circumferential direction on the basis of JISB 0601-2001 standard.

The measurement was performed at positions of 30, 70, 150, and 210 mm from a coating upper end in a longitudinal direction of the electrophotographic photoreceptor, and was similarly performed at 30, 70, 150, and 210 mm from a coating upper end after turning the electrophotographic photoreceptor forward by 120°. The measurement was similarly performed after further turning the electrophotographic photoreceptor forward by 120°, and Rzjis and Rsm were obtained on the basis of an average value of measured values at a total of 12 points. The measurement was performed under the conditions that a measurement length was 2.5 mm, a cutoff value was 0.8 mm, a feed speed was 0.1 mm/s, a filter characteristic was 2CR, and leveling was along a straight line (entire range).

TABLE 4

| | Electrophotographic | | Electrophotographic | |
|---|---|---|---|---|
| | photoreceptor surface | | photoreceptor surface | |
| | layer hardness | | layer hardness | |
| | HU | We (%) | Ra (μm) | Sm (mm) |
| Electrophotographic photoreceptor 1 | 212 | 37 | 0.005 | 0.002 |
| Electrophotographic photoreceptor 2 | 249 | 52 | 0.005 | 0.002 |
| Electrophotographic photoreceptor 3 | 235 | 43 | 0.005 | 0.002 |
| Electrophotographic photoreceptor 4 | 212 | 37 | 0.008 | 0.007 |
| Electrophotographic photoreceptor 5 | 249 | 52 | 0.008 | 0.022 |
| Electrophotographic photoreceptor 6 | 235 | 43 | 0.051 | 0.018 |
| Electrophotographic photoreceptor 7 | 248 | 50 | 0.062 | 0.008 |
| Electrophotographic photoreceptor 8 | 242 | 46 | 0.005 | 0.002 |
| Electrophotographic photoreceptor 9 | 250 | 51 | 0.005 | 0.002 |
| Electrophotographic photoreceptor 10 | 249 | 51 | 0.011 | 0.01 |
| Electrophotographic photoreceptor 11 | 250 | 52 | 0.012 | 0.018 |
| Electrophotographic photoreceptor 12 | 248 | 51 | 0.045 | 0.005 |
| Electrophotographic photoreceptor 13 | 215 | 38 | 0.011 | 0.005 |
| Electrophotographic photoreceptor 14 | 249 | 52 | 0.021 | 0.019 |
| Electrophotographic photoreceptor 15 | 216 | 38 | 0.018 | 0.018 |
| Electrophotographic photoreceptor 16 | 248 | 48 | 0.011 | 0.006 |
| Electrophotographic photoreceptor 17 | 225 | 40 | 0.011 | 0.008 |
| Electrophotographic photoreceptor 18 | 250 | 51 | 0.044 | 0.018 |
| Comparative electrophotographic photoreceptor 1 | 207 | 36 | 0.005 | 0.002 |
| Comparative electrophotographic photoreceptor 2 | 251 | 53 | 0.005 | 0.002 |
| Comparative electrophotographic photoreceptor 3 | 254 | 54 | 0.005 | 0.002 |
| Comparative electrophotographic photoreceptor 4 | 254 | 54 | 0.021 | 0.008 |
| Comparative electrophotographic photoreceptor 5 | 270 | 44 | 0.018 | 0.009 |

<Manufacturing of Intermediate Transfer Body 1>

(Producing of Base Layer)

A bottle-shaped molded body was obtained by stretch-blowing a polyethylene naphthalate (PEN) resin in which carbon black as an electric resistance adjuster was dispersed. The bottle-shaped molded body was cut to have an endless belt shape by using an ultrasonic cutter. The endless belt made of the PEN resin having a thickness of 60 μm, obtained in the above-described way, was used as a base layer of the intermediate transfer body 1.

(Preparation of Coating Liquid for Surface Layer Formation)

In a vessel shielded from ultraviolet light, 50 parts of PTFE particles (Lubron L-2: manufactured by Daikin Industries, Ltd.) having a primary particle diameter of 200 nm, 100 parts of an unsaturated double bond-containing acrylic copolymer (OPSTAR Z7501 manufactured by JSR Corporation), 25 parts of a zinc antimonate particle-containing isopropanol sol (Cernax CX-Z210IP manufactured by Nissan Chemical Industries, Ltd.), and 50 parts of methyl isobutyl ketone were mixed. The mixed liquid was dispersed and mixed by a high-pressure emulsifying dispersing machine such that an ultraviolet curable resin composition was prepared and used as a coating liquid for surface layer formation.

(Producing of Surface Layer)

The produced base layer was dip-coated with the coating liquid for surface layer formation under a coating environment of a temperature of 25° C. and a humidity of 60% RH. The coating film of the coating liquid for surface layer formation was irradiated with ultraviolet rays by using an ultraviolet irradiation device (product name: UE06/81-3, manufactured by Eye Graphics Co., Ltd., cumulative light amount: 1000 mJ/cm²) after 10 seconds from the completion of coating in the identical environments, and thus the unsaturated double bond-containing acrylic copolymer was cured. In the above-described way, the intermediate transfer body 1 provided with a surface layer having a thickness of 0.5 μm and having the cured acrylic resin as a main component, formed on the base layer was obtained. A volume resistivity of the intermediate transfer body 1 is 1.0×10¹⁰ Ω·cm. A circumferential length was 712 mm, and a width was 248 mm.

<Manufacturing of Intermediate Transfer Bodies 2 to 4>

In manufacturing of a surface layer of the intermediate transfer body 1, the intermediate transfer body 2 was obtained in the same method as in the intermediate transfer body 1 except that a thickness of a surface layer was 3 μm.

Surface finishing treatment was performed by bringing a wrapping film into contact with the intermediate transfer body 2, and thus the intermediate transfer body 3 of which grooves parallel to the circumferential direction are formed on a surface was obtained. A width of each of the grooves of the surface of the intermediate transfer body 3 was 2 μm, a depth thereof was 1 μm, and a pitch therebetween was 10 μm.

Surface finishing treatment was performed by bringing a wrapping film into contact with the intermediate transfer body 2, and thus the intermediate transfer body 3 of which grooves having an angle of 5° with respect to the circumferential direction are formed on a surface was obtained. A width of each of the grooves of the surface of the intermediate transfer body 3 was 2 μm, a depth thereof was 1 μm, and a pitch therebetween was 10 μm.

<Manufacturing of Comparative Intermediate Transfer Bodies 1 to 3>

In manufacturing of the intermediate transfer body 1, the comparative intermediate transfer body 1 was obtained in the same method as in the intermediate transfer body 1 except that a surface layer was not produced.

In the comparative intermediate transfer body 1, the comparative intermediate transfer body 2 was obtained in the same method as in the comparative intermediate transfer body 1 except that polyether ether ketone resin (PEEK) was used as a material of a base layer, and a thickness thereof was set to a thickness shown in Table 5.

In the comparative intermediate transfer body 1, the comparative intermediate transfer body 3 was obtained in the same method as in the comparative intermediate transfer body 1 except that a polyimide (PI) resin was used as a material of a base layer, and a thickness thereof was set to a thickness shown in Table 5.

[Evaluation of Intermediate Transfer Bodies]

A hardness of each of surfaces of the obtained intermediate transfer bodies was measured in the same method as in measurement of a hardness of a surface of an electrophotographic photoreceptor. Evaluation results are shown in Table 5.

TABLE 5
Configuration of intermediate transfer body and hardness of surface

| | | | | | | | Surface | | |
|---|---|---|---|---|---|---|---|---|---|
| | | | | | | | shape | | |
| | | | | | | | Presence | | |
| | | | | | | | or | | |
| | | | | | | | absence | | |
| | Base layer | | | Surface layer | | | of | | |
| | Material | Thickness | | Material | Thickness | | groove | — | HU |
| Intermediate transfer body 1 | PEN | 60 | μm | Acryl | 0.5 | μm | Absent | — | 50 |
| Intermediate transfer body 2 | PEN | 60 | μm | Acryl | 3 | μm | Absent | — | 81 |
| Intermediate transfer body 3 | PEN | 60 | μm | Acryl | 3 | μm | Present | 0° | 81 |
| Intermediate transfer body 4 | PEN | 60 | μm | Acryl | 3 | μm | Present | 5° | 81 |

| | | | | | | | | |
|---|---|---|---|---|---|---|---|---|
| Comparative intermediate | PEN | 60 | μm | No | — | Absent | — | 39 |
| transfer body 1 | | | | | | | | |
| Comparative intermediate | PEEK | 50 | μm | No | — | Absent | — | 110 |
| transfer body 2 | | | | | | | | |
| Comparative intermediate | PI | 65 | μm | No | — | Absent | — | 197 |
| transfer body 3 | | | | | | | | |

### Example 1

The following evaluation was performed by using the obtained electrophotographic photoreceptor 1, toner 1, and intermediate transfer body 4. Results thereof are shown in Table 6.

<Image Forming Apparatus>

A modified printer of the commercially available laser beam printer LBP712Ci manufactured by Canon was used. Modifications are that a developing roller was set to be rotated at twice the circumferential velocity of an electrophotographic photoreceptor by changing gears and software of an evaluation printer main body, a process speed was changed to 300 mm/sec, and the circumferential velocity difference dVn was set to 3% by rotationally driving an electrophotographic photoreceptor at a circumferential velocity of 291 mm/sec with respect to a circumferential velocity of 300 mm/sec of an intermediate transfer body.

A process cartridge of LBP712Ci was filled with 60 g of the toner 1, the electrophotographic photoreceptor 1 was attached thereto, and all process cartridges of yellow, magenta, cyan, and black were changed. The intermediate transfer body 4 was attached to a unit of LBP712Ci. All of the changed process cartridges were left for 24 hours under an environment of high temperature and high humidity (30° C. and 80% RH), and were attached to the modified printer of LBP712Ci.

In the environment of 30° C. and 80% RH, 5,000 sheets of a full-color 1.0% printing rate image were printed out on LETTER size XEROX Vitality paper (manufactured by XEROX Corporation, basis weight: 75 g/m²).

Thereafter, toner development characteristic evaluation, a discharge product attachment evaluation, and evaluation of damage on a surface of an electrophotographic photoreceptor were performed under the following conditions.

<Toner Development Characteristic Evaluation>

As described above, after 5000 sheets were printed out, a cyan halftone image (toner applied amount: 0.2 mg/cm²) was printed out on LETTER size XEROX Vitality paper (manufactured by XEROX Corporation, basis weight: 75 g/m²), and, as an indicator of toner durability, the presence or absence of vertical stripes in the paper discharge direction on the developing roller and on the image was evaluated. There is no problem in practical use up to the criterion B.

(Evaluation Criteria)

A: No vertical stripe is observed on the developing roller and the image.

B: Five or less thin stripes in the circumferential direction are observed at both ends of the developing roller. Alternatively, some vertical stripes in the paper discharge direction which can be erased through image processing are observed only on the image.

C: Thin stripes of six or more to twenty or less in the circumferential direction are observed at both ends of the developing roller. Alternatively, several fine stripes which cannot be erased through image processing are observed.

D: Stripes of twenty-one or more are observed on the developing roller and the image, and stripes on the image cannot be erased through image processing.

<Discharge Product Attachment Evaluation>

As described above, after 5,000 sheets were passed, cyan 8-grayscale vertical band halftone images (eight grayscales such as 1F, 3F, 5F, 7F, 9F, BF, DF, FF when solid is FFhex) were printed out on LETTER size XEROX Vitality paper (manufactured by XEROX Corporation, basis weight: 75 g/m²), and evaluation of discharge product attachment was performed. In a case where a discharge product is attached to the surface of the electrophotographic photoreceptor 1, an electrostatic latent image becomes shallow, and thus a phenomenon occurs that the density of an image is reduced, or an image is lost. There is no problem in practical use up to the criterion B.

(Evaluation Criteria)

A: Halftone images of all the eight grayscales can be visually recognized.

B: Among all the eight grayscales, halftone images of five or more grayscales can be visually recognized, and a halftone image of A rank can be printed out until subsequent ten sheets are printed out.

C: Among all the eight grayscales, halftone images of three or more grayscales can be visually recognized, and a halftone image of A rank can be printed out until subsequent thirty sheets are printed out.

D: Among all the eight grayscales, halftone images of three or more grayscales can be visually recognized, and a halftone image of A rank can be printed out until subsequent 100 sheets are printed out.

<Evaluation of Damage on Surface of Electrophotographic Photoreceptor>

As described above, after 5000 sheets were passed, a cyan halftone image (toner applied amount: 0.2 mg/cm²) was printed out on LETTER size XEROX Vitality paper (manufactured by XEROX Corporation, basis weight: 75 g/m²), and, damage on the surface of the electrophotographic photoreceptor was evaluated. In a case where damage occurs on the surface of the electrophotographic photoreceptor, a film thickness of the electrophotographic photoreceptor is reduced at a location where the damage occurs, a halftone density of the location where the damage occurs is reduced, and thus a white stripe is printed. There is no problem in practical use up to the criterion B.

(Evaluation criteria)

A: No vertical stripe is observed on the image.

B: Some vertical stripes in the paper discharge direction which can be erased through image processing are observed on the image.

C: Thin stripes of twenty or less which cannot be erased through image processing are observed on the image.

D: Stripes of twenty-one or more which cannot be erased through image processing are observed on the image.

### Examples 2 to 33 and Comparative Examples 1 to 13

An image forming apparatus was prepared in the same manner as in Example 1 except that an electrophotographic photoreceptor, toner, and an intermediate transfer body were changed as shown in Table 6, and toner development characteristic evaluation, a discharge product attachment evaluation, and evaluation of damage on a surface of an electrophotographic photoreceptor were performed. Results thereof are shown in Table 6.

In Example 33, evaluation was performed in the same manner as in Example 1 except that the circumferential velocity difference dVn during image formation was 3%, and the circumferential velocity difference dVs was set to 10% (a circumferential velocity of the electrophotographic photoreceptor 1 was 270 mm/sec with respect to a circumferential velocity of 300 mm/sec of the intermediate transfer body 4) by executing the special image forming mode during post-rotation right after an image was formed. In the comparative example 10, evaluation was performed in the same manner as in Example 1 except that a circumferential velocity difference is not provided (circumferential velocity difference dVn of 0%) during image formation.

TABLE 6

| | | | | | | Image forming | | |
|---|---|---|---|---|---|---|---|---|
| | | | | Circum- | Circum- | apparatus evaluation | | |
| | | | | ferential | ferential | Develop- | Attach- | |
| | | | | velocity | velocity | ment | ment | Damage |
| | | | | difference | difference | charac- | evalu- | evalu- |
| | Electrophotographic photoreceptor | Toner | Intermediate transfer body | dVn | dVs | teristic | ation | ation |
| Example 1 | Electrophotographic photoreceptor 1 | Toner 1 | Intermediate transfer body 4 | 3% | 0% | B | B | A |
| Example 2 | Electrophotographic photoreceptor 1 | Toner 2 | Intermediate transfer body 4 | 3% | 0% | B | B | A |
| Example 3 | Electrophotographic photoreceptor 2 | Toner 3 | Intermediate transfer body 4 | 3% | 0% | B | B | A |
| Example 4 | Electrophotographic photoreceptor 2 | Toner 1 | Intermediate transfer body 4 | 3% | 0% | B | B | A |
| Example 5 | Electrophotographic photoreceptor 1 | Toner 2 | Intermediate transfer body 4 | 3% | 0% | B | B | A |
| Example 6 | Electrophotographic photoreceptor 2 | Toner 3 | Intermediate transfer body 4 | 3% | 0% | B | B | A |
| Example 7 | Electrophotographic photoreceptor 3 | Toner 4 | Intermediate transfer body 4 | 3% | 0% | B | B | A |
| Example 8 | Electrophotographic photoreceptor 4 | Toner 4 | Intermediate transfer body 4 | 3% | 0% | B | B | A |
| Example 9 | Electrophotographic photoreceptor 5 | Toner 5 | Intermediate transfer body 4 | 3% | 0% | B | B | A |
| Example 10 | Electrophotographic photoreceptor 6 | Toner 6 | Intermediate transfer body 4 | 3% | 0% | B | B | A |
| Example 11 | Electrophotographic photoreceptor 7 | Toner 7 | Intermediate transfer body 4 | 3% | 0% | B | B | A |
| Example 12 | Electrophotographic photoreceptor 8 | Toner 3 | Intermediate transfer body 4 | 3% | 0% | B | B | A |
| Example 13 | Electrophotographic photoreceptor 9 | Toner 3 | Intermediate transfer body 4 | 3% | 0% | B | B | A |
| Example 14 | Electrophotographic photoreceptor 4 | Toner 8 | Intermediate transfer body 4 | 3% | 0% | B | B | A |
| Example 15 | Electrophotographic photoreceptor 11 | Toner 4 | Intermediate transfer body 4 | 3% | 0% | B | B | A |
| Example 16 | Electrophotographic photoreceptor 12 | Toner 8 | Intermediate transfer body 4 | 3% | 0% | B | B | A |
| Example 17 | Electrophotographic photoreceptor 13 | Toner 9 | Intermediate transfer body 4 | 3% | 0% | B | B | A |
| Example 18 | Electrophotographic photoreceptor 14 | Toner 8 | Intermediate transfer body 4 | 3% | 0% | B | B | A |
| Example 19 | Electrophotographic photoreceptor 15 | Toner 10 | Intermediate transfer body 4 | 3% | 0% | A | B | A |
| Example 20 | Electrophotographic photoreceptor 16 | Toner 11 | Intermediate transfer body 4 | 3% | 0% | A | B | A |
| Example 21 | Electrophotographic photoreceptor 14 | Toner 12 | Intermediate transfer body 4 | 3% | 0% | A | B | A |
| Example 22 | Electrophotographic photoreceptor 15 | Toner 13 | Intermediate transfer body 4 | 3% | 0% | A | B | A |
| Example 23 | Electrophotographic photoreceptor 14 | Toner 14 | Intermediate transfer body 4 | 3% | 0% | A | B | A |
| Example 24 | Electrophotographic photoreceptor 16 | Toner 16 | Intermediate transfer body 4 | 3% | 0% | A | B | A |
| Example 25 | Electrophotographic photoreceptor 14 | Toner 17 | Intermediate transfer body 4 | 3% | 0% | A | B | A |
| Example 26 | Electrophotographic photoreceptor 17 | Toner 5 | Intermediate transfer body 4 | 3% | 0% | B | B | A |
| Example 27 | Electrophotographic photoreceptor 18 | Toner 8 | Intermediate transfer body 4 | 3% | 0% | B | B | A |
| Example 28 | Electrophotographic photoreceptor 17 | Toner 9 | Intermediate transfer body 4 | 3% | 0% | B | B | A |
| Example 29 | Electrophotographic photoreceptor 18 | Toner 8 | Intermediate transfer body 4 | 3% | 0% | B | B | A |
| Example 30 | Electrophotographic photoreceptor 1 | Toner 1 | Intermediate transfer body 1 | 3% | 0% | B | B | A |
| Example 31 | Electrophotographic photoreceptor 1 | Toner 1 | Intermediate transfer body 2 | 3% | 0% | B | B | A |
| Example 32 | Electrophotographic photoreceptor 1 | Toner 1 | Intermediate transfer body 3 | 3% | 0% | B | B | A |
| Example 33 | Electrophotographic photoreceptor 1 | Toner 1 | Intermediate transfer body 4 | 3% | 10% | B | A | B |
| Comparative | Comparative electrophotographic | Comparative | Intermediate transfer body 4 | 3% | 0% | C | B | C |
| example 1 | photoreceptor 1 | toner 1 | | | | | | |
| Comparative | Comparative electrophotographic | Comparative | Intermediate transfer body 4 | 3% | 0% | C | B | C |
| example 2 | photoreceptor 2 | toner 1 | | | | | | |
| Comparative | Comparative electrophotographic | Comparative | Intermediate transfer body 4 | 3% | 0% | C | B | C |
| example 3 | photoreceptor 1 | toner 2 | | | | | | |
| Comparative | Comparative electrophotographic | Comparative | Intermediate transfer body 4 | 3% | 0% | C | B | C |
| example 4 | photoreceptor 2 | toner 2 | | | | | | |
| Comparative | Comparative electrophotographic | Comparative | Intermediate transfer body 4 | 3% | 0% | C | B | D |
| example 5 | photoreceptor 3 | toner 3 | | | | | | |
| Comparative | Comparative electrophotographic | Comparative | Intermediate transfer body 4 | 3% | 0% | C | B | D |
| example 6 | photoreceptor 4 | toner 3 | | | | | | |
| Comparative | Comparative electrophotographic | Comparative | Intermediate transfer body 4 | 3% | 0% | C | B | D |
| example 7 | photoreceptor 4 | toner 3 | | | | | | |
| Comparative | Comparative electrophotographic | Comparative | Intermediate transfer body 4 | 3% | 0% | D | B | D |
| example 8 | photoreceptor 3 | toner 4 | | | | | | |
| Comparative | Comparative electrophotographic | Comparative | Intermediate transfer body 4 | 3% | 0% | D | B | D |
| example 9 | photoreceptor 5 | toner 4 | | | | | | |
| Comparative | Electrophotographic | Toner 1 | Intermediate transfer body 4 | 0% | 0% | B | D | A |
| example 10 | photoreceptor 1 | | | | | | | |
| Comparative | Electrophotographic | Toner 1 | Comparative intermediate | 3% | 0% | B | C | B |
| example 11 | photoreceptor 1 | | transfer body 1 | | | | | |
| Comparative | Electrophotographic | Toner 1 | Comparative intermediate | 3% | 0% | B | B | C |
| example 12 | photoreceptor 1 | | transfer body 2 | | | | | |
| Comparative | Electrophotographic | Toner 1 | Comparative intermediate | 3% | 0% | B | A | D |
| example 13 | photoreceptor 1 | | transfer body 3 | | | | | |

### OTHER EMBODIMENTS

Values of the circumferential velocity differences dVn and dVs may be changed depending on environmental conditions. Specifically, values of dVn and dVs are set to be greater under high temperature and high humidity under which an image defect more remarkably occurs due to attachment of a discharge product than under normal environments, and thus it is possible to suppress the occurrence of an image defect.

Values of the circumferential velocity differences dVn and dVs may be changed depending on the number of printed sheets using the image forming apparatus. Specifically, values of dVn and dVs are set to be greater at the time of the number of printed sheets being larger at which an image defect more remarkably occurs due to attachment of a discharge product, for example, at the time of 5000 sheets or more than at the time of the number of printed sheets being small.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-105575, filed May 31, 2018, which is hereby incorporated by reference herein in its entirety.

What is claimed is:

1. An image forming apparatus comprising:
an electrophotographic photoreceptor;
a developing unit that develops toner so as to form a toner image on the electrophotographic photoreceptor; and
an intermediate transfer body that conveys a toner image which is primarily transferred from the electrophotographic photoreceptor to be secondarily transferred onto a transfer material,
wherein the toner includes a toner particle having a toner base containing a coloring agent and a binder resin, and a surface layer containing an organosilicon polymer,
a sticking ratio of the organosilicon polymer to the toner base is 85.0% or more to 99.0% or less,
the electrophotographic photoreceptor has a supporting member, a photosensitive layer, and a surface layer in this order,
a universal hardness value (HU) of the surface layer is 210 or more to 250 or less (N/mm²), and an elastic deformation ratio (We) is 37% or more to 52% or less,
a surface of the intermediate transfer body has a universal hardness value (HU) of 50 or more to 100 or less (N/mm²), and
wherein the image forming apparatus further comprises a unit that provides a circumferential velocity difference dVn between a circumferential velocity of the electrophotographic photoreceptor and a circumferential velocity of the intermediate transfer body.

2. The image forming apparatus according to claim 1,
wherein the surface layer of the electrophotographic photoreceptor has a structure represented by the following Formula (A-1) and a structure represented by the following Formula (A-2): 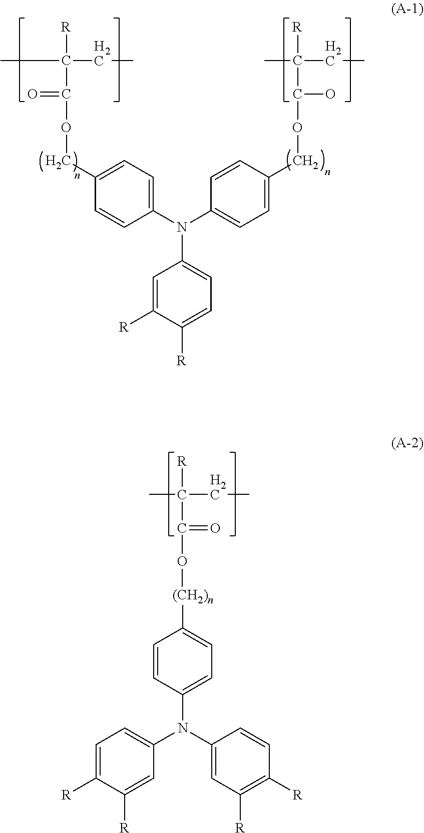
in Formula (A-1) and Formula (A-2), R represents a hydrogen atom or a methyl group, and n is 2 or 3.

3. The image forming apparatus according to claim 1,
wherein the organosilicon polymer has a partial structure represented by the following Formula (B), a content of the organosilicon polymer in the toner is 0.5% by mass or more to 5.0% by mass or less, the organosilicon polymer forms a projection shape in the surface layer of the toner particle, and a projection height is in a range of 40 nm or more to 100 nm or less:
R¹—SiO_{3/2} (B)
in Formula (B), R¹ represents a hydrocarbon group of which the number of carbon atoms is one or more to six or less.

4. The image forming apparatus according to claim 1,
wherein the surface layer of the electrophotographic photoreceptor has a shape of which Ra is in a range of 0.010 μm or more to 0.045 μm or less, and Sm is in a range of 0.005 mm or more to 0.060 mm or less.

5. The image forming apparatus according to claim 1,
wherein a Martens hardness of the toner measured under a condition of the maximum load of 2.0×10⁻⁴ N is 200 MPa or more to 1100 MPa or less.

6. The image forming apparatus according to claim 1,
wherein the intermediate transfer body has an endless shape, and has a groove on the surface thereof, the groove elongated in a circumferential direction of the intermediate transfer body.

7. The image forming apparatus according to claim 6,
wherein the groove is formed in a spiral shape.

8. The image forming apparatus according to claim 1, further comprising:
a unit that provides a circumferential velocity difference dVs greater than the circumferential velocity difference dVn.

9. The image forming apparatus according to claim 8, further comprising:
a unit that changes at least one of the circumferential velocity difference dVn and the circumferential velocity difference dVs according to an ambient environmental condition or a use condition of the image forming apparatus.

10. An image forming method comprising:
developing toner so as to form a toner image on an electrophotographic photoreceptor;
primarily transferring a toner image formed on the electrophotographic photoreceptor onto an intermediate transfer body; and
conveying the toner image transferred on the intermediate transfer body to be secondarily transferred onto a transfer material,
wherein the toner includes a toner particle having a toner base containing a coloring agent and a binder resin, and a surface layer containing an organosilicon polymer,
a sticking ratio of the organosilicon polymer to the toner base is 85.0% or more to 99.0% or less,
the electrophotographic photoreceptor has a supporting member, a photosensitive layer, and a surface layer in this order,
a universal hardness value (HU) of the surface layer is 210 or more to 250 or less (N/mm²), and an elastic deformation ratio (We) is 37% or more to 52% or less,
a surface of the intermediate transfer body has a universal hardness value (HU) of 50 or more to 100 or less (N/mm²), and
wherein, in the primarily transferring, a circumferential velocity difference dVn is provided between a circumferential velocity of the electrophotographic photoreceptor and a circumferential velocity of the intermediate transfer body.

11. The image forming method according to claim 10,
wherein the surface layer of the electrophotographic photoreceptor has a structure represented by the following Formula (A-1) and a structure represented by the following Formula (A-2): 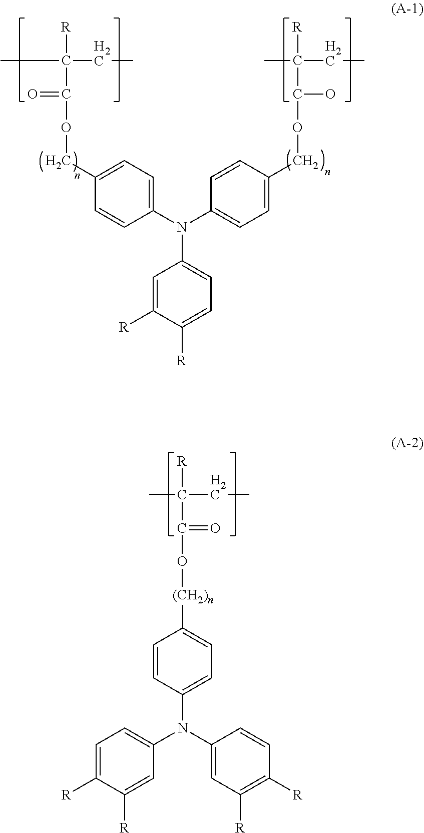
in Formula (A-1) and Formula (A-2), R represents a hydrogen atom or a methyl group, and n is 2 or 3.

12. The image forming method according to claim 10,
wherein the organosilicon polymer has a partial structure represented by the following Formula (B), a content of the organosilicon polymer in the toner is 0.5% by mass or more to 5.0% by mass or less, the organosilicon polymer forms a projection shape in the surface layer of the toner particle, and a projection height is in a range of 40 nm or more to 100 nm or less:
R¹—SiO_{3/2} (B)
in Formula (B), R¹ represents a hydrocarbon group of which the number of carbon atoms is one or more to six or less.

13. The image forming method according to claim 10,
wherein the surface layer of the electrophotographic photoreceptor has a shape of which Ra is in a range of 0.010 μm or more to 0.045 μm or less, and Sm is in a range of 0.005 mm or more to 0.060 mm or less.

14. The image forming method according to claim 10,
wherein a Martens hardness of the toner measured under a condition of the maximum load of 2.0×10⁴ N is 200 MPa or more to 1100 MPa or less.

15. The image forming method according to claim 10,
wherein the intermediate transfer body has an endless shape, and has a groove elongated in a circumferential direction of the intermediate transfer body.

16. The image forming method according to claim 15,
wherein the groove is formed in a spiral shape.

17. The image forming method according to claim 10,
wherein a circumferential velocity difference dVs greater than the circumferential velocity difference dVn is provided.

18. The image forming method according to claim 17,
wherein at least one of the circumferential velocity difference dVn and the circumferential velocity difference dVs is changed according to an ambient environmental condition or a use condition of the image forming apparatus.
